(19) United States
(12) Patent Application Publication
(10) Pub. No.: US 2023/0306978 A1
(43) Pub. Date: Sep. 28, 2023

(54) CODING APPARATUS, DECODING APPARATUS, CODING METHOD, DECODING METHOD, AND HYBRID CODING SYSTEM

(71) Applicant: PANASONIC INTELLECTUAL PROPERTY CORPORATION OF AMERICA, Torrance, CA (US)

(72) Inventors: Yuichi KAMIYA, Ishikawa (JP); Takuya KAWASHIMA, Ishikawa (JP); Hiroyuki EHARA, Kanagawa (JP); Akira HARADA, Kanagawa (JP)

(73) Assignee: PANASONIC INTELLECTUAL PROPERTY CORPORATION OF AMERICA, Torrance, CA (US)

(21) Appl. No.: 18/011,390

(22) PCT Filed: Apr. 22, 2021
(86) PCT No.: PCT/JP2021/016320

§ 371 Date: Dec. 19, 2022

(30) Foreign Application Priority Data
Jul. 7, 2020 (JP) 2020-117124
Oct. 14, 2020 (JP) 2020-173259
Oct. 29, 2020 (JP) 2020-181197

(51) Int. Cl. G10L 19/20; G10L 19/02; G10L 19/005; G10L 19/12; G10L 19/008

(52) U.S. Cl. CPC G10L 19/20; G10L 19/0204; G10L 19/005; G10L 19/12; G10L 19/008

(57) ABSTRACT

A coding apparatus includes: a first coding circuit that codes an input signal selectively using coding in a time domain or a frequency domain according to the characteristic of the input signal in a core layer; and a second coding circuit that codes an error in coding by the first coding circuit using a coding method corresponding to the domain type of coding used in the core layer in an extension layer for the core layer.

### TECHNICAL FIELD

The present disclosure relates to an encoder, a decoder, a coding method, a decoding method, and a hybrid coding system.

### BACKGROUND ART

For example, there is a low-bit-rate multimode coding technique for a speech/audio signal (see, for example, Non-Patent Literature (hereinafter referred to as “NPL”) 1).

### CITATION LIST

### Patent Literature

### Patent Literature 1

WO 01/47283

### Non-Patent Literature

### NPL 1

3GPP TS 26.445 V16.0.0, “Codec for Enhanced Voice Services (EVS); Detailed Algorithmic Description (Release 16)”, 2019 June.

### NPL 2

ITU-T G.729.1, “G.729-based embedded variable bit-rate coder: An 8-32 kbit/s scalable wideband coder bitstream interoperable with G.729”, 2006 May

### NPL 3

ITU-T G.711.1, “Wideband embedded extension for ITU-T G.711 pulse code modulation” (Appendix IV, “Mid-side stereo coding”), 2012 September

### SUMMARY OF INVENTION

### Technical Problem

However, there is room for consideration on a method of improving coding performance in multimode coding.

One non-limiting and exemplary embodiment facilitates providing an encoder, a decoder, a coding method, a decoding method, and a hybrid coding system each improving coding performance in multimode coding.

An encoder according to an exemplary embodiment of the present disclosure includes: first coding circuitry, which, in operation, encodes an input signal by selectively using, in a core layer, coding in a time domain or a frequency domain in accordance with a characteristic of the input signal; and second coding circuitry, which, in operation, encodes a coding error by the first coding circuitry by using, in an extension layer with respect to the core layer, a coding method corresponding to a domain type of the coding used in the core layer.

It should be noted that general or specific embodiments may be implemented as a system, an apparatus, a method, an integrated circuit, a computer program, a storage medium, or any selective combination thereof.

According to an exemplary embodiment of the present disclosure, it is possible to improve coding performance in multimode coding.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an example of a configuration of a Mid-Side (MS) stereo coding/decoding system;

FIG. 2 illustrates an example of a configuration of a coding system;

FIG. 3 is a block diagram illustrating an example of a configuration of a decoding system;

FIG. 4 is a block diagram illustrating an example of a configuration of an encoder in Linear Prediction (LP)-based coding mode;

FIG. 5 is a flowchart illustrating an example of processing by the encoder in the LP-based coding mode;

FIG. 6 is a block diagram illustrating a variation of the configuration of the encoder in the LP-based coding mode;

FIG. 7 is a block diagram illustrating a variation of the configuration of the encoder in the LP-based coding mode;

FIG. 8 is a block diagram illustrating a variation of the configuration of the encoder in the LP-based coding mode;

FIG. 9 is a block diagram illustrating an example of a configuration of a decoder in the LP-based coding mode;

FIG. 10 is a flowchart illustrating an example of processing by the decoder in the LP-based coding mode;

FIG. 11 is a block diagram illustrating a variation of the configuration of the decoder in the LP-based coding mode;

FIG. 12 is a block diagram illustrating a variation of the configuration of the decoder in the LP-based coding mode;

FIG. 13 is a block diagram illustrating an example of a configuration of the encoder in Modified Discrete Cosine Transform (MDCT)-based Transform Coded eXcitation (TCX) mode;

FIG. 14 is a flowchart illustrating an example of processing by the encoder in the MDCT-based TCX mode;

FIG. 15 is a block diagram illustrating an example of a configuration of the decoder in the MDCT-based TCX mode;

FIG. 16 is a flowchart illustrating an example of processing by the decoder in the MDCT-based TCX mode;

FIG. 17 is a block diagram illustrating an example of a configuration of the encoder in Low Rate-High Quality (LR-HQ) mode;

FIG. 18 is a flowchart illustrating an example of processing by the encoder in the LR-HQ mode;

FIG. 19 is a block diagram illustrating an example of a configuration of the decoder in the LR-HQ mode;

FIG. 20 is a flowchart illustrating an example of processing by the decoder in the LR-HQ mode;

FIG. 21 illustrates an example of a configuration of a hybrid coding system; and

FIG. 22 illustrates an example of a configuration of a hybrid decoding system.

### DESCRIPTION OF EMBODIMENTS

Hereinafter, embodiments of the present disclosure will be described in detail with reference to the accompanying drawings.

For example, NPL 1 discloses a multimode coding technique (or a multimode speech/audio coding/decoding technique) with a low bit rate such as 13.2 kbps in an Enhanced Voice Services (EVS) codec. NPL 1 discloses, however, dual mono coding for a stereo signal (for example, a method of encoding each channel of a stereo signal as a monaural signal), but does not discuss a coding method for a Mid-Side (MS) stereo signal.

Further, for example, NPL 2 discloses a scalable (or embedded) coding technique in which an extension layer is added to an 8 kbps speech codec. NPL 2 discloses, however, a technique in which a low-bit-rate speech codec in a single mode is extended to perform coding of a high-quality speech/audio signal, but does not discuss multimode coding. For example, when the technique disclosed in NPL 2 is applied to multimode speech coding, an extension layer is generated for a plurality of modes and the codec may be complicated. Further, a processing amount or informational amount of the codec may increase (for example, a program Read Only Memory (ROM) may increase).

Further, for example, NPL 3 discloses MS stereo coding technique using G.711.1 codec. NPL 3 discloses, however, a method of applying a monaural speech/audio codec to an MS stereo signal, but does not discuss a coding method having scalability.

Given the above, in an exemplary embodiment of the present disclosure, a method of improving coding performance in scalable coding with low-bit-rate multimode coding as a core for the MS stereo signal will be described.

[Example of Configuration of MS Stereo Coding/Decoding System]

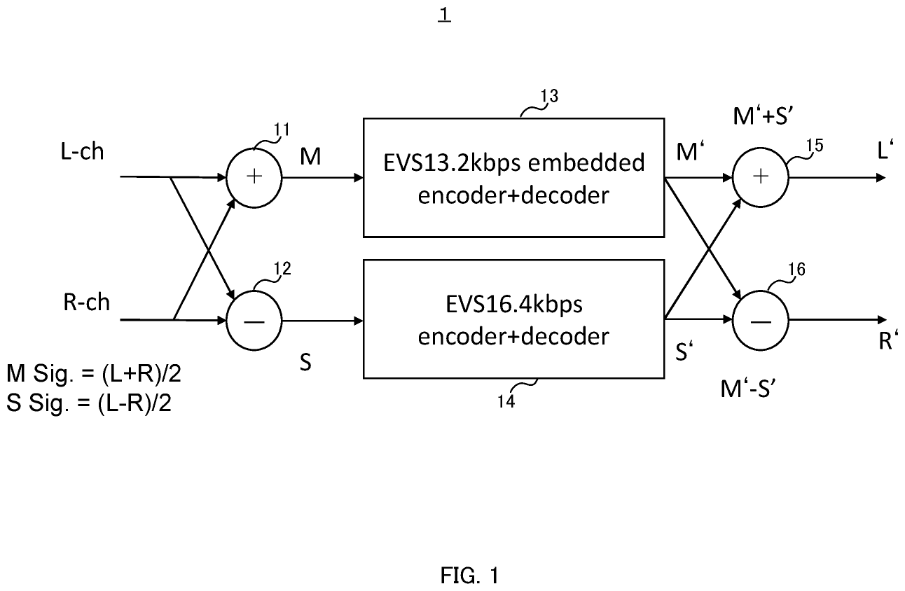

FIG. 1 illustrates an example of a configuration of MS stereo coding/decoding system 1.

For example, a stereo signal including an L-channel (Left channel) and an R-channel (Right channel) may be inputted to MS stereo coding/decoding system 1.

In MS stereo coding/decoding system 1, adder 11 may generate, for example, a sum signal (also referred to as an M signal, an M channel signal, a Mid signal, or a Middle signal, for example) indicating a sum of the L-channel (a left-channel signal) and the R-channel (a right-channel signal). Further, subtractor 12 may generate, for example, a difference signal (also referred to as an S signal, an S channel signal, or a Side signal, for example) indicating a difference between the L-channel and the R-channel. In other words, the L-channel and the R-channel may be converted to two channels of the M channel and the S channel.

For example, the M signal may be given by M(t)=0.5×(L(t)+R(t)), and the S signal may be given by S(t)=0.5×(L(t)−R(t)). Note that, the expressions of the M signal and the S signal are not limited thereto, L and R may be interchanged, and a constant other than 0.5 times or a variable may be applied.

In FIG. 1, the M signal (M) may be inputted to, for example, EVS 13.2 kbps embedded encoder+decoder 13 (hereinafter may be referred to as “EVS 13.2 kbps embedded encoder/decoder 13”) with an EVS 13.2 kbps codec as a core. For example, EVS 13.2 kbps embedded encoder/decoder 13 may perform coding processing and decoding processing of the M signal and output a decoded M signal (M′) to adder 15 and subtractor 16.

Note that, the configuration and operation of the EVS 13.2 kbps codec to be described in an exemplary embodiment of the present disclosure may be based on, for example, the configuration and operation disclosed in NPL 1.

Further, in FIG. 1, the S signal (S) may be inputted, for example, to EVS 16.4 kbps encoder+decoder 14 (hereinafter may be referred to as “EVS 16.4 kbps encoder/decoder 14”). For example, EVS 16.4 kbps encoder/decoder 14 may perform coding processing and decoding processing of the S signal and output a decoded S signal (S′) to adder 15 and subtractor 16.

For example, adder 15 may add the decoded M signal (M′) and the decoded S signal (S′) and output a decoded L-channel signal (L′). Further, for example, subtractor 16 may calculate a difference between the decoded M signal (M′) and the decoded S signal (S′) and output a decoded R-channel signal (R′).

For example, since M(t)+S(t)=0.5×(L(t)+R(t))+0.5×(L(t)−R(t))=L(t), a decoded L signal is determined by the addition of the decoded M signal and the decoded S signal. In the same manner, for example, since M(t)−S(t)=0.5×(L(t)+R(t))−0.5×(L(t)−R(t))=R(t), a decoded R signal is determined by the subtraction of the decoded M signal from the decoded S signal. Note that, for example, in a case where the L-channel and the R-channel are interchanged or another constant instead of 0.5 times or a variable is used in the equation described above at the time of the conversion from the LR signals to the MS signals, inverse transform corresponding thereto may be performed.

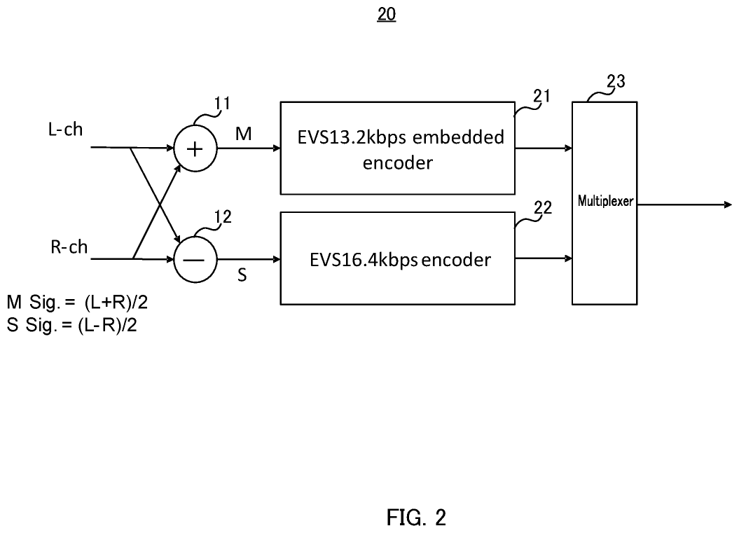

FIG. 2 illustrates an example of a configuration of a coding side (referred to as coding system 20, for example) in MS stereo coding/decoding system 1 indicated in FIG. 1. Note that, in FIG. 2, the same configuration processors as those in FIG. 1 (for example, adder 11 and subtractor 12) are denoted by the same reference signs and descriptions thereof will be omitted.

For example, EVS 13.2 kbps embedded encoder 21 may perform coding processing of the M signal to be inputted and output a coding result (for example, coding information of the M signal) to multiplexer 23. For example, EVS 16.4 kbps encoder 22 may perform coding processing of the S signal to be inputted and output a coding result (for example, coding information of the S signal) to multiplexer 23. For example, multiplexer 23 may multiplex the coding information of the M signal inputted from EVS 13.2 kbps embedded encoder 21 and the coding information of the S signal inputted from EVS 16.4 kbps encoder 22, and output the generated multiplexed signal (for example, an MS stereo coding bitstream) to a transmission path or a storage apparatus.

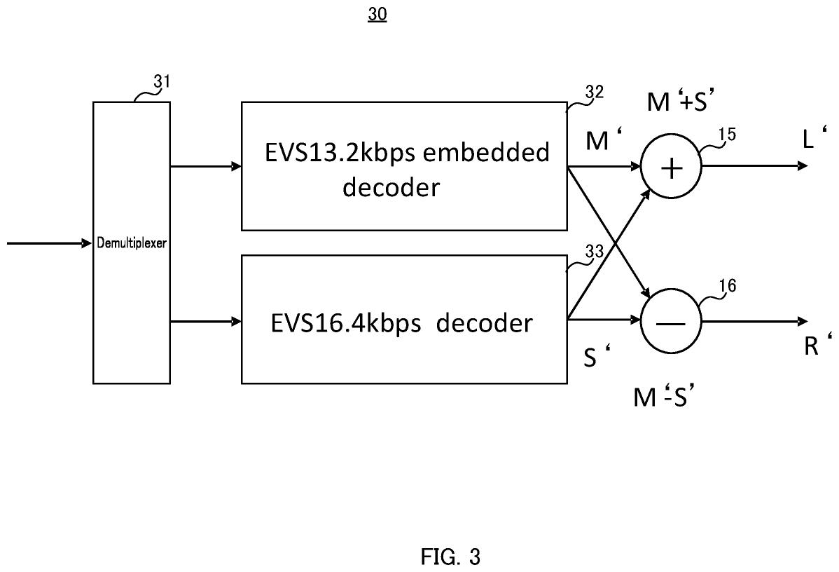

FIG. 3 illustrates an example of a configuration of a decoding side (referred to as decoding system 30, for example) in MS stereo coding/decoding system 1 indicated in FIG. 1. Note that, in FIG. 3, the same configuration processors as those in FIG. 1 (for example, adder 15 and subtractor 16) are denoted by the same reference signs and descriptions thereof will be omitted.

Demultiplexer 31 may separate the MS stereo coding bitstream (for example, the output signal from multiplexer 23 in FIG. 2) inputted from the transmission path or the storage apparatus into the coding information of the M signal and the coding information of the S signal. For example, demultiplexer 31 may output the coding information of the M signal to EVS 13.2 kbps embedded decoder 32 and output the coding information of the S signal to EVS 16.4 kbps decoder 33. For example, EVS 13.2 kbps embedded decoder 32 may perform decoding processing of the coding information of the M signal inputted from demultiplexer 31 and output the decoded M signal (M′) to adder 15 and subtractor 16. For example, EVS 16.4 kbps decoder 33 may perform decoding processing of the coding information of the decoded S signal inputted from demultiplexer 31 and output the decoded signal S (S′) to adder 15 and subtractor 16.

An example of the configuration of MS stereo coding/decoding system 1 has been described above.

For example, EVS 13.2 kbps embedded encoder 21 indicated in FIG. 2 may be a scalable encoder in which a 32 kbps extension coding layer (the extension coding layer will also be referred to as an extension layer) is incorporated into an EVS 13.2 kbps core coding layer (the core coding layer will also be referred to as a core layer).

Here, the EVS 13.2 kbps of the core layer may include three coding modes, for example. The three coding modes are, for example, “LP-based coding mode”, “MDCT-based TCX coding mode”, and “LR-HQ coding mode”. For example, EVS 13.2 kbps embedded encoder 21 may switch between these coding modes in accordance with a feature of an input signal.

The LP-based coding mode is, for example, a coding mode in a time domain. In addition, the LP-based coding mode may further include a plurality of coding modes (also referred to as sub-modes) in accordance with a feature of an input signal.

Further, the MDCT-based TCX coding mode and the LR-HQ coding mode are, for example, coding modes in a frequency domain.

EVS 13.2 kbps embedded encoder 21 and EVS 13.2 kbps embedded decoder 32 may determine (in other words, select or switch), for example, a coding mode (or a coding method) used for coding in the extension layer based on a coding mode used for coding in the core layer.

For example, EVS 13.2 kbps embedded encoder 21 may encode (for example, core layer coding) an input signal (for example, the M signal of the MS stereo signal) by selectively using, in the core layer, coding (for example, a coding mode) in a time domain or a frequency domain in accordance with a characteristic of the input signal, and may encode (for example, extension layer coding) a coding error by the core layer coding by using, in the extension layer with respect to the core layer, coding (or a coding mode) corresponding to a domain type (for example, the time domain or the frequency domain) of the coding used in the core layer.

Further, for example, EVS 13.2 kbps embedded decoder 32 may decode coding information (for example, core layer coding information) of an input signal (for example, the M signal of the MS stereo signal) encoded by selectively using, in the core layer, coding in a time domain or a frequency domain in accordance with a characteristic of the input signal, and may decode coding information (for example, extension layer coding information) of a coding error by the core layer coding, where the coding error is encoded by using, in the extension layer with respect to the core layer, a coding method corresponding to a domain type of the coding used in the core layer.

Hereinafter, coding processing by EVS 13.2 kbps embedded encoder 21 and decoding processing by EVS 13.2 kbps embedded decoder 32 in a case where each of the LP-based coding mode, the MDCT-based TCX coding mode, and the LR-HQ coding mode is used as the coding mode in the core layer will be described as an example.

[LP-Based Coding Mode]

<Example of Configuration of Encoder>

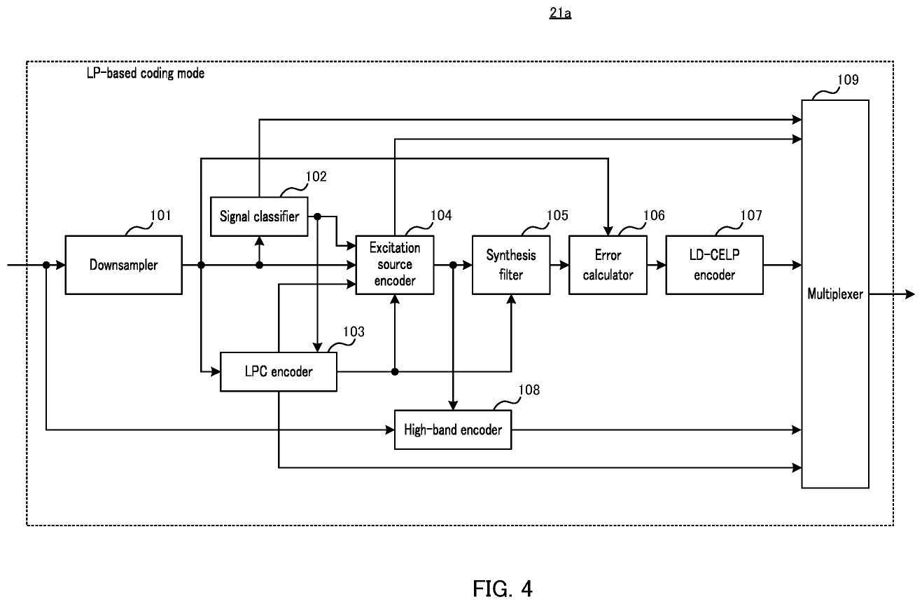

FIG. 4 is a block diagram illustrating an example of a configuration of EVS 13.2 kbps embedded encoder 21a in the LP-based coding mode. Note that, hereinafter, EVS 13.2 kbps embedded encoder 21a in the LP-based coding mode will also be referred to as “encoder 21a”.

Encoder 21a may include, for example, downsampler 101, signal classifier 102, Linear Predictive Coding (LPC) encoder 103, excitation source encoder 104, synthesis filter 105, error calculator 106, Low Delay-Code Excited Linear Prediction (LD-CELP) encoder 107, high-band encoder 108, and multiplexer 109.

In FIG. 4, a configuration processor (corresponding to coding circuitry in the core layer, for example) that performs the coding in the core layer may include, for example, signal classifier 102, LPC encoder 103, excitation source encoder 104, and high-band encoder 108. Further, in FIG. 4, a configuration processor that performs the coding in the extension layer (corresponding to coding circuitry in the extension layer, for example) may include, for example, error calculator 106 and LD-CELP encoder 107.

For example, an input signal such as the M signal of the MS stereo signal may be inputted to encoder 21a.

In FIG. 4, for example, downsampler 101 may downsample the input signal. For example, downsampler 101 may downsample the input signal to a sampling frequency of 12.8 kHz. Note that, the sampling frequency is not limited to 12.8 kbps, but may be any other value. For example, downsampler 101 may output the signal subjected to the downsampling (also referred to as the downsample signal, for example) to signal classifier 102, LPC encoder 103, excitation source encoder 104, and error calculator 106.

Signal classifier 102 may classify, for example, the input signal based on the signal inputted from downsampler 101. For example, signal classifier 102 may select one of a plurality of coding modes (also referred to as sub-modes) in the LP-based coding mode based on the classification of the input signal (in other words, a feature of the input signal). For example, signal classifier 102 may output mode information (or signal classification information) indicating the selected coding mode to LPC encoder 103 and excitation source encoder 104. Further, for example, signal classifier 102 may encode the mode information and output a coding result (referred to as “mode coding information”, for example) to multiplexer 109.

Note that, signal classifier 102 may be provided in a stage before downsampler 101 as part of preprocessing by encoder 21a (for example, encoder) in its entirety. Alternatively, for example, signal classifier 102 may perform signal classification processing by using both the signals before and after downsampler 101.

LPC encoder 103 may perform, for example, a linear prediction analysis on the signal inputted from downsampler 101 to encode a linear predictive coefficient (LPC). Further, for example, LPC encoder 103 may output the LPC before the coding to excitation source encoder 104. For example, LPC encoder 103 may quantize and encode the linear predictive coefficient (LPC) based on the coding mode (or sub-mode) indicated in the mode information inputted from signal classifier 102. For example, LPC encoder 103 may output the quantized LPC (or decoded LPC) to excitation source encoder 104 and synthesis filter 105 and output a coding result (referred to as “LPC coding information”, for example) to multiplexer 109. Note that, the LPC coding by LPC encoder 103 may be performed, for example, in a domain of a line spectrum frequency (for example, LSF: Linear Spectral Frequency).

For example, excitation source encoder 104 may quantize and encode, based on the signal inputted from downsampler 101 and the LPC and quantized LPC inputted from LPC encoder 103, an excitation source signal of a linear prediction filter (also referred to as a synthesis filter) configured by using the quantized LPC. Further, for example, excitation source encoder 104 may perform coding of an excitation source signal based on the coding mode (or sub-mode) indicated in the mode information inputted from signal classifier 102. For example, excitation source encoder 104 may output the quantized excitation source signal (or decoded excitation source signal) to synthesis filter 105 and high-band encoder 108. Further, for example, excitation source encoder 104 may output a coding result of the excitation source signal (referred to as “excitation source coding information”, for example) to multiplexer 109.

For example, synthesis filter 105 may drive, based on the quantized LPC inputted from LPC encoder 103 and the quantized excitation source signal inputted from excitation source encoder 104, a synthesis filter configured by using the quantized LPC. For example, synthesis filter 105 may output a synthesis signal to be generated (in other words, a decoded signal) to error calculator 106.

For example, error calculator 106 may calculate, based on the downsample signal inputted from downsampler 101 (in other words, a signal to be subjected to the core layer coding) and the synthesis signal inputted from synthesis filter 105 (in other words, the decoded signal in the core layer coding), a coding error (referred to as a coding error signal, for example) in the core layer coding. For example, error calculator 106 may output the coding error signal to LD-CELP encoder 107.

For example, LD-CELP encoder 107 may perform LD-CELP coding on the coding error signal inputted from error calculator 106. For example, LD-CELP encoder 107 may output a coding result (referred to as “LD-CELP coding information” or “extension layer coding information”, for example) to multiplexer 109.

High-band encoder 108 may perform, for example, coding of a high-band signal based on the input signal (for example, the M signal) and the quantized excitation source signal inputted from excitation source encoder 104. For example, high-band encoder 108 may output a coding result (referred to as “high-band coding information”, for example) to multiplexer 109.

Multiplexer 109 may multiplex, for example, the mode coding information inputted from signal classifier 102, the LPC coding information inputted from LPC encoder 103, the excitation source coding information inputted from excitation source encoder 104, the LD-CELP coding information inputted from LD-CELP encoder 107, and the high-band coding information inputted from high-band encoder 108. For example, multiplexer 109 may output a coding bitstream (for example, an EVS 13.2 kbps embedded coding bitstream) including the multiplexed signal to the transmission path or the storage apparatus.

Note that, the configuration of LD-CELP encoder 107 may be the same configuration as the configuration described in ITU-T Recommendation G.728, for example. Further, it is 256 samples in a case where the frame length (for example, 20 ms) of the EVS codec is 12.8 kHz sampled, for example. For this reason, for example, the excitation source vector length in G.728 may be changed from five samples to four samples or eight samples. This change, for example, causes the frame length of the EVS codec to become an integral multiple of the excitation source vector length and makes it possible to simplify the processing by LD-CELP encoder 107. For example, in a case where the excitation source vector length in G.728 is configured to four samples, the excitation source codebook may use the excitation source codebook in G.728 as is for four samples, may be designed exclusively for LD-CELP encoder 107, or may be designed as a pulse source used in G.729, G.723.1 or the like.

Further, for example, the update of the state of the backward predictor used in G.728 may not be performed in a case where the coding mode in the EVS codec differs from the LP-based coding mode, but may be performed. For example, in a case where coding modes different from the LP-based coding mode continue to be selected, processing of gradually bringing the state of the backward predictor closer to the initial value may be performed.

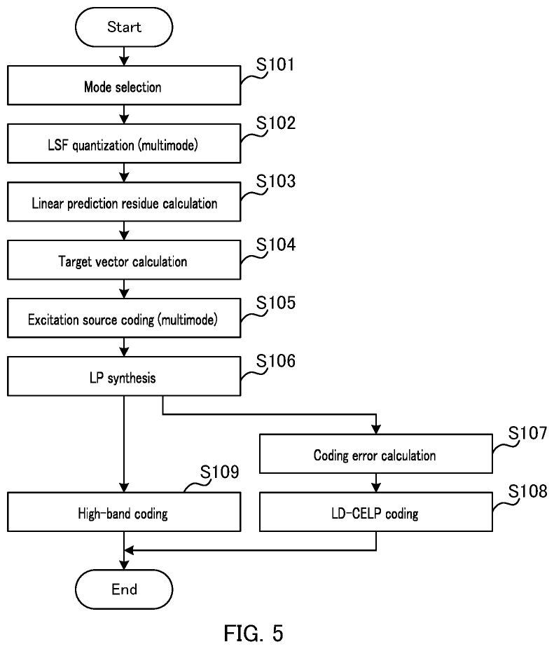

FIG. 5 is a flowchart illustrating an example of coding processing by encoder 21a.

In FIG. 5, for example, encoder 21a (for example, signal classifier 102) may select a coding mode (for example, a multimode ACELP coding mode) in the LP-based coding mode based on a 12.8 kHz sampling input signal (for example, the downsample signal) (S101). For example, encoder 21a may determine bit allocation in coding of an input signal (for example, the coding in the core layer) based on the selected coding mode.

Encoder 21a (for example, LPC encoder 103) may perform, for example, LSF quantization (in other words, LPC coding) of the input signal based on the selected coding mode (S102).

For example, encoder 21a (for example, excitation source encoder 104) may calculate a linear predictive residual signal by using a quantized LPC inverse filter based on a result of the LSF quantization (S103), calculate a target vector based on the linear predictive residual signal (S104), and perform excitation source coding based on the selected coding mode (S105).

Encoder 21a (for example, synthesis filter 105) may perform synthesis filter processing (also referred to as LP synthesis processing) (S106).

Encoder 21a (for example, error calculator 106) may calculate, for example, a coding error signal based on the input signal and the synthesis signal obtained by the synthesis filter processing (S107). Further, encoder 21a (for example, LD-CELP encoder 107) may perform, for example, LD-CELP coding processing on the coding error signal (S108).

Further, encoder 21a (for example, high-band encoder 108) may perform, for example, high-band coding (for example, time-domain bandwidth extension coding) of the input signal (S109).

Further, for example, encoder 21a may update various memories based on a result of the coding processing.

<Variation of Example of Configuration of Encoder>

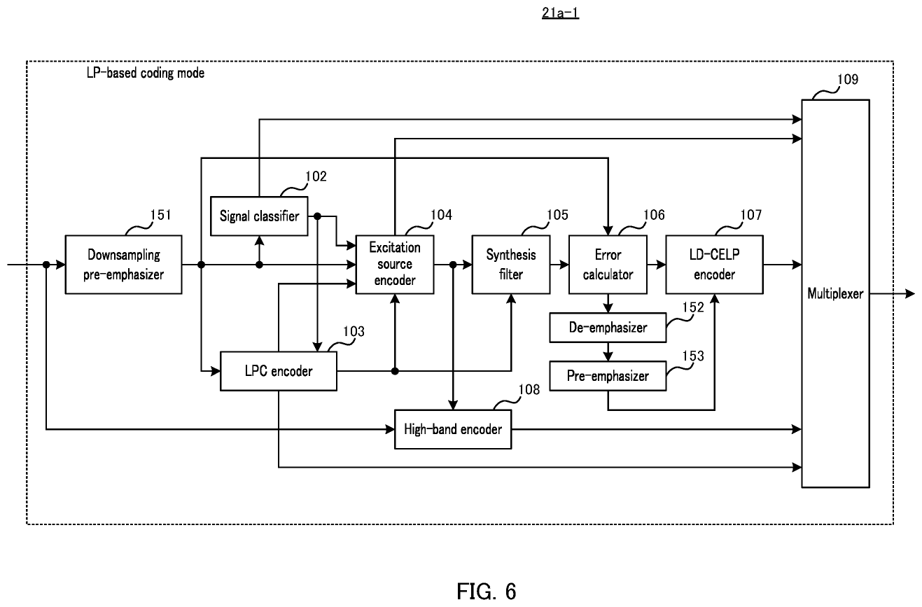

FIGS. 6, 7 and 8 are block diagrams illustrating variations of the configuration of EVS 13.2 kbps embedded encoder 21a in the LP-based coding mode.

The differences between FIGS. 6, 7 and 8 and FIG. 4 lie in, for example, that pre-emphasis processing is performed after the downsampling in the EVS codec, and that pre-emphasis processing differing from the pre-emphasis processing by the EVS codec in emphasis intensity is performed on the input signal to LD-CELP encoder 107.

Note that, in FIGS. 6, 7 and 8, the same configuration elements common to those in FIG. 4 are denoted by the same numbers and descriptions thereof will be omitted.

Encoder 21a indicated in FIGS. 6, 7 and 8 (for example, encoders 21a-1, 21a-2, and 21a-3) may be configured to include, for example, downsampling pre-emphasizer 151, de-emphasizer 152, and pre-emphasizer 153.

In the configuration processor that performs the coding in the core layer (corresponding to the coding circuitry in the core layer, for example) indicated in FIGS. 6, 7 and 8, for example, downsampling pre-emphasizer 151 may perform first pre-emphasis processing on the signal subjected to the downsampling. In other words, in FIGS. 6, 7 and 8, the signal that is outputted from downsampling pre-emphasizer 151 and is inputted to LPC encoder 103 and excitation source encoder 104 is a signal on which the first pre-emphasis processing is performed.

Further, in the configuration processor that performs the coding in the extension layer (corresponding to the coding circuitry in the extension layer, for example) indicated in

FIGS. 6, 7 and 8, for example, de-emphasizer 152 may perform first de-emphasis processing, and pre-emphasizer 153 may perform second pre-emphasis processing.

In FIGS. 6, 7 and 8, downsampling pre-emphasizer 151 may perform, for example, the first pre-emphasis processing on the signal obtained by downsampling the input signal to the sampling frequency of 12.8 kHz. Note that, the first pre-emphasis processing may be, for example, processing in which the transfer function is given by H(z)=1−βz⁻¹ as described in NPL 1 (Section 5.1.4 Pre-Emphasis). For example, β=0.68 may be configured as described in NPL 1, but the present disclosure is not limited thereto, and β may be any other value.

In FIGS. 6, 7 and 8, it can be said that error calculator 106 performs the same processing as in FIG. 4 in terms of calculating the coding error (referred to as the coding error signal, for example) in the core layer coding based on the signal to be subjected to the core layer coding and the decoded signal in the core layer coding, and outputting the coding error signal to LD-CELP encoder 107. However, the content of processing differs in the following point. For example, the pre-emphasis processing (the second pre-emphasis processing) differing from the first pre-emphasis processing by downsampling pre-emphasizer 151 in intensity is applied to the error signal calculated by error calculator 106, and the error signal subjected to the second pre-emphasis processing is outputted to LD-CELP encoder 107.

FIG. 6 illustrates an example of a configuration in which de-emphasizer 152 and pre-emphasizer 153 apply the first de-emphasis processing and the second pre-emphasis processing to the error signal calculated by error calculator 106, for example.

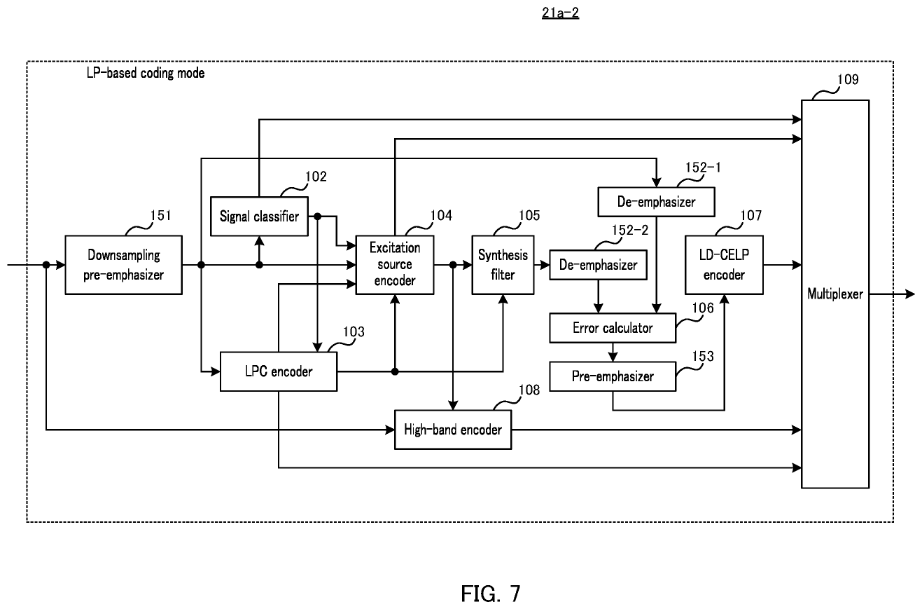

FIG. 7 illustrates an example of a configuration in which de-emphasizer 152-1 and de-emphasizer 152-2 perform the first de-emphasis processing on each of the input signals to error calculator 106 (for example, the signal to be subjected to the core layer coding and the decoded signal in the core layer coding) and pre-emphasizer 153 applies the second pre-emphasis processing to the error signal subjected to the first de-emphasis processing, for example.

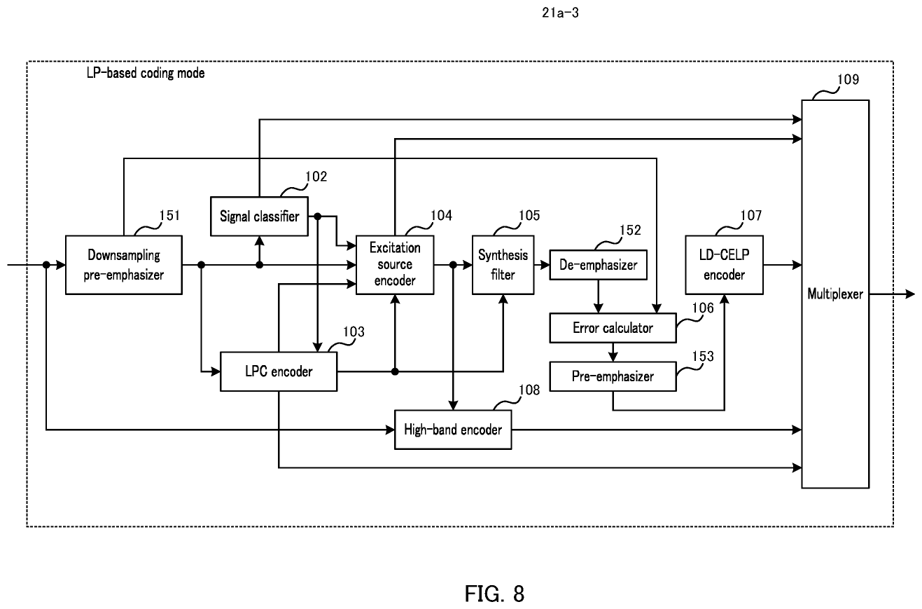

FIG. 8 illustrates an example of a configuration in which error calculator 106 calculates an error signal between the signal from downsampling pre-emphasizer 151, which is before application of the first pre-emphasis processing (in other words, is subjected to the downsampling), and the signal obtained by application of the first de-emphasis processing to the decoded signal in the core layer coding by de-emphasizer 152, and in which pre-emphasizer 153 applies the second pre-emphasis processing on the error signal, for example.

Note that, the first pre-emphasis processing may be, for example, processing in which the transfer function is given by H(z)=1−βz⁻¹ as described in NPL 1 (Section 5.1.4 Pre-Emphasis), and β=0.68 may be configured as described in NPL 1. Further, the first de-emphasis processing may be processing (of an inverse characteristic of pre-emphasis) in which the transfer function is given by H(z)=1/(1−βz⁻¹) as described in NPL 1 (Section 6.4 De-emphasis).

Further, the emphasis intensity in the second pre-emphasis/de-emphasis processing may be configured to be weaker than that in the first pre-emphasis/de-emphasis processing, for example. For example, in a case where the value of β in the first pre-emphasis/de-emphasis processing is configured to be 0.68, the value of β in the second pre-emphasis/de-emphasis processing may be configured to be 0.3. Note that, the values of β in the first and second pre-emphasis/de-emphasis processing are not limited to these values.

Further, in FIG. 6, for example, there is a part in which de-emphasizer 152 that performs the first de-emphasis processing and pre-emphasizer 153 that performs the second pre-emphasis processing are in cascade connection. This part may be, for example, collectively configured as one block to be third de-emphasis processing having a transfer function obtained by multiplying the transfer function of the first de-emphasis processing by the transfer function of the second pre-emphasis processing.

<Example of Configuration of Decoder>

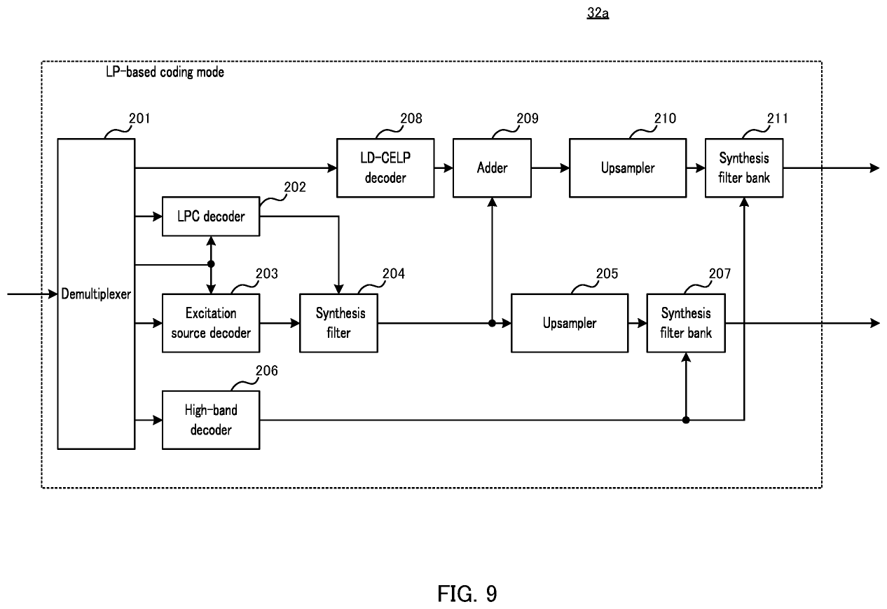

FIG. 9 is a block diagram illustrating an example of a configuration of EVS 13.2 kbps embedded decoder 32a in the LP-based coding mode. Note that, hereinafter, EVS 13.2 kbps embedded decoder 32a in the LP-based coding mode will also be referred to as “decoder 32a”.

Decoder 32a may include, for example, demultiplexer 201, LPC decoder 202, excitation source decoder 203, synthesis filter 204, upsampler 205, high-band decoder 206, synthesis filter bank 207, LD-CELP decoder 208, adder 209, upsampler 210, and synthesis filter bank 211.

In FIG. 9, a configuration processor that performs decoding in the core layer (corresponding to decoding circuitry in the core layer, for example) may include, for example, LPC decoder 202, excitation source decoder 203, synthesis filter 204, and high-band decoder 206. In FIG. 9, a configuration processor that performs decoding in the extension layer (corresponding to decoding circuitry in the extension layer, for example) may include, for example, LD-CELP decoder 208 and adder 209.

Demultiplexer 201 may separate, for example, a coding bitstream inputted from the transmission path or the storage apparatus into mode coding information, LPC coding information, excitation source coding information, high-band coding information, and LD-CELP coding information. Demultiplexer 201 may output, for example, the mode coding information to LPC decoder 202 and excitation source decoder 203, output the LPC coding information to LPC decoder 202, output the excitation source coding information to excitation source decoder 203, output the high-band coding information to high-band decoder 206, and output LD-CELP coding information to LD-CELP decoder 208.

For example, LPC decoder 202 may decode the LPC coding information based on the mode coding information inputted from demultiplexer 201 and output decoded LPC information to synthesis filter 204.

For example, excitation source decoder 203 may decode the excitation source coding information based on the mode coding information inputted from demultiplexer 201 and output decoded excitation source signal to synthesis filter 204.

Synthesis filter 204 may configure, for example, a linear prediction filter (or an LP synthesis filter) by using a linear predictive coefficient (LPC) included in the decoded LPC information inputted from LPC decoder 202. Further, for example, synthesis filter 204 may perform synthesis filter processing by using the decoded excitation source signal inputted from excitation source decoder 203 as a driving signal of the LP synthesis filter and output an LP synthesis signal (in other words, a decoded signal) to upsampler 205 and adder 209.

Upsampler 205 may upsample, for example, the LP synthesis signal inputted from synthesis filter 204. For example, upsampler 205 may upsample a 12.8 kHz sampling signal to a sampling frequency of 32 kHz or 48 kHz. Note that, the sampling frequency is not limited to 32 kbps and 48 kbps, but may be any other value. Upsampler 205 may output, for example, the signal subjected to the upsampling to synthesis filter bank (FB) 207.

For example, high-band decoder 206 may decode the high-band coding information inputted from demultiplexer 201 and output a decoded high-band signal to synthesis FB 207 and synthesis FB 211.

For example, synthesis FB 207 may output a decoded signal (for example, with no extension layer and a decoding result of EVS 13.2 kbps coding) based on the signal inputted from upsampler 205 and the decoded high-band signal inputted from high-band decoder 206.

For example, LD-CELP decoder 208 may decode the LD-CELP coding information inputted from demultiplexer 201 and output a decoded LD-CELP signal to adder 209.

For example, adder 209 may add the LP synthesis signal (in other words, the decoded signal in the core layer) inputted from synthesis filter 204 and the decoded LD-CELP signal (in other words, the coding error in the coding in the core layer) inputted from LD-CELP decoder 208 and output the addition result to upsampler 210.

Upsampler 210 may upsample, for example, the signal inputted from adder 209. Upsampler 210 may output, for example, the signal subjected to the upsampling to synthesis FB 211. Note that, upsampler 210 may perform, for example, postprocessing of enhancing the perceptual quality of the decoded signal, such as post-filtering processing, before or after the upsampling.

Synthesis FB 211 may output, for example, a decoded signal (for example, a decoding result of embedded coding including the extension layer) based on the signal inputted from upsampler 210 and the high-band signal inputted from high-band decoder 206.

Note that, the operation of upsampler 205 may be the same as, for example, the operation of upsampler 210. Further, the operation of synthesis FB 211 may be the same as, for example, the operation of synthesis FB 207. For example, upsampler 205 and synthesis FB 207, and, upsampler 210 and synthesis FB 211, may be shared. For example, the input to the upsampler to be shared may be selectively switched between the output of synthesis filter 204 and the output of adder 209.

Alternatively, upsampler 210 and synthesis FB 211 may be used and upsampler 205 and synthesis FB 207 may not be used. In this case, decoder 32a may be configured to, for example, turn ON/OFF the output of LD-CELP decoder 208. For example, in a case where the output of LD-CELP decoder 208 is OFF (output: zero), the output of synthesis filter 204 is inputted to upsampler 210. On the other hand, for example, in a case where the output of LD-CELP decoder 208 is ON, an addition result of the output of adder 209 and the output of LD-sCELP decoder 208 is inputted to upsampler 210.

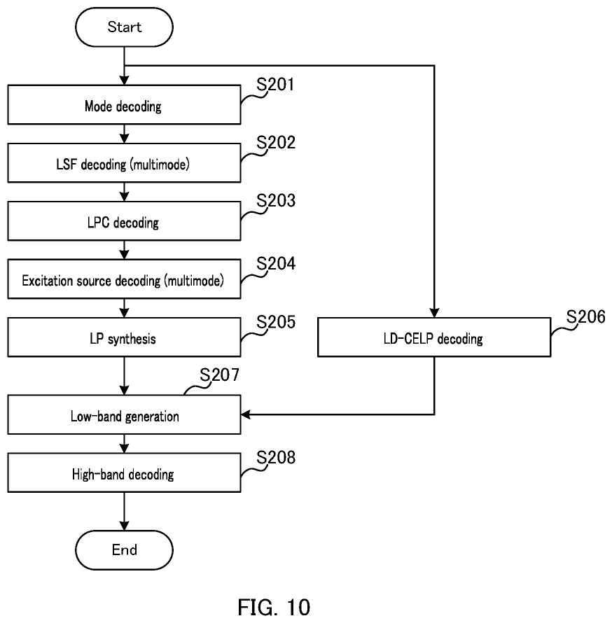

FIG. 10 is a flowchart illustrating an example of decoding processing by decoder 32a.

In FIG. 10, decoder 32a (for example, LPC decoder 202 and excitation source decoder 203) may decode, for example, the mode coding information (for example, coding mode of multimode ACELP) (S201). For example, decoder 32a may determine bit allocation in accordance with the coding mode of multimode ACELP.

For example, decoder 32a (for example, LPC decoder 202) may perform LSF decoding and LSF interpolation based on the coding mode (S202), perform conversion to LPC, and decode the LP synthesis filter (S203).

For example, decoder 32a (for example, excitation source decoder 203) may decode a gain (or predicted energy) and perform excitation source decoding based on the coding mode (S204).

Decoder 32a (for example, synthesis filter 204) may obtain, for example, a decoded synthesis signal with the decoded excitation source signal as a driving signal of the decoded LP synthesis filter (S205).

Decoder 32a (for example, LD-CELP decoder 208) may perform, for example, LD-CELP decoding processing (S206).

For example, decoder 32a (for example, adder 209) may add the decoded LD-CELP signal and the decoded synthesis signal to generate a low-band signal (S207).

Decoder 32a (for example, high-band decoder 206 and synthesis FB 211) may perform, for example, time-domain bandwidth extension processing (for example, decoding of a high-band signal and synthesis filter bank processing) (S208).

An example of the decoding processing by decoder 32a has been described above.

Thus, in a case where the coding mode used in the core layer is the LP-based coding mode (for example, the time-domain coding mode or the CELP coding mode), the coding method in the extension layer may be independent of, for example, a plurality of modes in the LP-based coding mode (for example, a plurality of candidate coding methods in the coding in the time domain). For example, in a case where the coding mode in the core layer is the time-domain coding mode, encoder 21a may perform coding of a coding error by using, in the extension layer, a coding mode (for example, LD-CELP) robust to a plurality of modes (or a feature of the input signal) in the time-domain coding mode.

This coding in the extension layer allows, for example, unified extension layer coding for a plurality of coding modes in a time-domain coding mode in extension of a low-bit-rate multimode coding scheme. For this reason, it is possible to simplify processing by encoder 21a and decoder 32a. Further, for example, addition of different extension layers for each of the plurality of coding modes in the time-domain coding mode can be suppressed and complication of coding processing and decoding processing can be suppressed.

Further, for example, since the coding of the coding error is performed without using a look-ahead component from a future frame, for example, in the extension layer by the coding in the extension layer by the LD-CELP, an additional algorithmic delay can be suppressed.

Note that, the coding scheme in the extension layer is not limited to the LD-CELP, but may be any other coding scheme. For example, waveform coding such as Adaptive Differential Pulse Code Modulation (ADPCM) or PCM may be applied instead of the LD-CELP. Further, a coding scheme in which no additional algorithm delay occurs (for example, look-ahead is not required), which is robust against characteristics of the input signal (for example, a model specialized for a specific signal is not used), and in which processing can be performed with a frame length whose length (divisor) matches a frame length of core coding (for example, EVS codec) may be applied to the coding scheme in the extension layer, for example.

<Variation of Example of Configuration of Decoder>

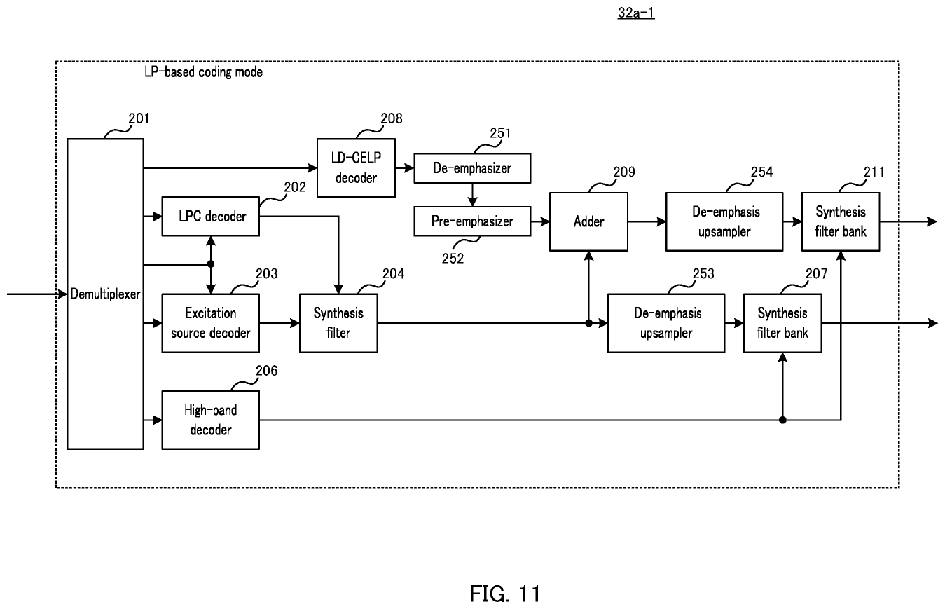

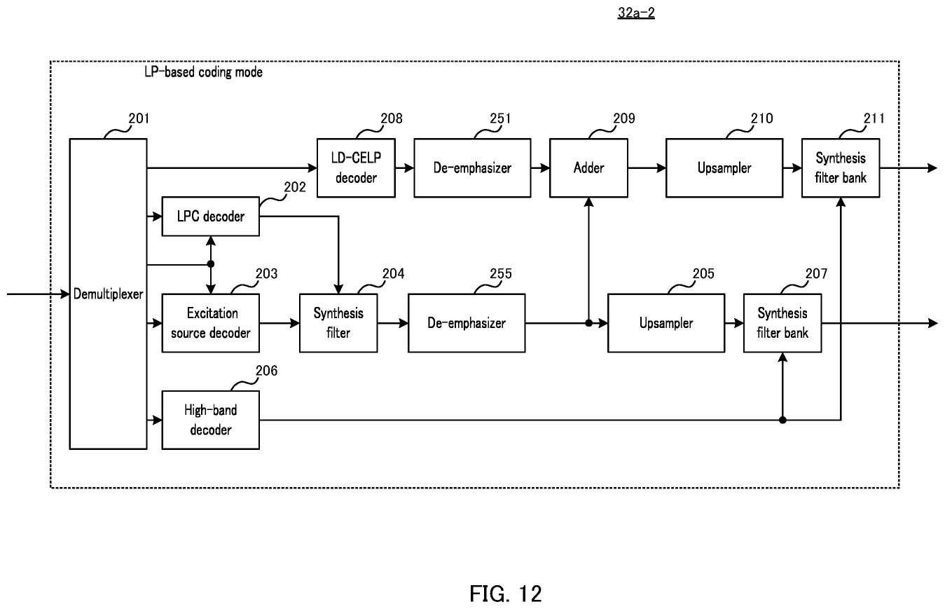

FIGS. 11 and 12 are block diagrams illustrating variations of the example of the configuration of EVS 13.2 kbps embedded decoder 32a in the LP-based coding mode.

The differences between FIGS. 11 and 12 and FIG. 9 lie in that, for example, the first de-emphasis processing is performed before the upsampling by the EVS codec, and that the second de-emphasis processing differing from the de-emphasis processing by the EVS codec in emphasis intensity is performed on the decoded LD-CELP signal outputted from LD-CELP decoder 208.

Note that, in FIGS. 11 and 12, the same configuration elements common to those in FIG. 9 are denoted by the same numbers and descriptions thereof will be omitted.

In a configuration processor that performs the decoding in the core layer (corresponding to the decoding circuitry in the core layer, for example) indicated in FIGS. 11 and 12, for example, de-emphasis upsampler 253 or de-emphasizer 255 may perform the first de-emphasis processing on the signal before the upsampling. Further, in a configuration processor that performs the decoding in the extension layer (corresponding to the decoding circuitry in the extension layer, for example) indicated in FIGS. 11 and 12, for example, de-emphasizer 251 may perform the second de-emphasis processing.

In FIGS. 11 and 12, de-emphasis upsampler 253 or de-emphasizer 255 may perform, for example, the first de-emphasis processing before upsampling the LP synthesis signal. Note that, the de-emphasis processing may be, for example, processing in which the transfer function is given by H(z)=1/(1−βz⁻¹) as described in NPL 1 (Section 6.4 De-emphasis). For example, β=0.68 may be configured as described in NPL 1, but the present disclosure is not limited thereto, and β may be any other value.

In FIGS. 11 and 12, it can be said that adder 209 performs the same processing as in FIG. 9 in terms of adding the decoded signal in the core layer and the coding error in the coding in the core layer and outputting the addition result to de-emphasis upsampler 254 or upsampler 210. However, the content of processing differs in the following point.

For example, different pieces of pre-emphasis processing are applied to the decoded signal in the core layer and the coding error signal in the coding in the core layer on a side of the encoder (for example, the first pre-emphasis processing to the coding in the core layer and the second pre-emphasis processing to the coding in the extension layer). For this reason, decoders 32a-1 and 32a-2 indicated in FIGS. 11 and 12 apply the first de-emphasis processing to the decoded signal in the core layer, apply the second de-emphasis processing to the coding error signal in the coding in the core layer, and perform addition processing and upsampling processing such that both the addition signals are to be subjected to upsampling.

In FIGS. 11 and 12, upsampler 210 or de-emphasis upsampler 254 may upsample, for example, the signal inputted from adder 209. Upsampler 210 may output, for example, the signal subjected to the upsampling to synthesis FB 211. Note that, upsampler 210 may perform, for example, postprocessing of enhancing the perceptual quality of the decoded signal, such as post-filtering processing, before or after the upsampling.

Decoder 32a-1 indicated in FIG. 11 may be configured to include, for example, de-emphasizer 251 that performs the second de-emphasis processing, and pre-emphasizer 252. For example, FIG. 11 illustrates an example of a configuration in which de-emphasizer 251 and pre-emphasizer 252 apply the second de-emphasis processing and the first pre-emphasis processing to the decoded signal in the LD-CELP, adder 209 adds the decoded signal in the core layer to the decoded signal in the LD-CELP, to which the second de-emphasis processing and the first pre-emphasis processing have been applied, to calculate an addition signal in a domain to which the first pre-emphasis processing has been applied, and de-emphasis upsampler 254 performs the first de-emphasis processing before the upsampling processing.

FIG. 12 illustrates an example of a configuration in which de-emphasizer 251 applies the second de-emphasis processing to the decoded signal in the LD-CELP, de-emphasizer 255 applies the first de-emphasis processing to the decoded signal in the core layer, adder 209 performs addition processing in a domain before the pre-emphasis processing (in other words, in a case where downsampling has been performed) on a side of the encoder, and upsamplers 205 and 210 only perform upsampling processing.

Note that, in FIG. 11, for example, there is a part in which de-emphasizer 251 that performs the second de-emphasis processing and pre-emphasizer 252 that performs the first pre-emphasis processing are in cascade connection. This part may be, for example, collectively configured as one block to be third de-emphasis processing having a transfer function obtained by multiplying the transfer function of the second de-emphasis processing by the transfer function of the first pre-emphasis processing.

[MDCT-based TCX Coding Mode]

<Example of Configuration of Encoder>

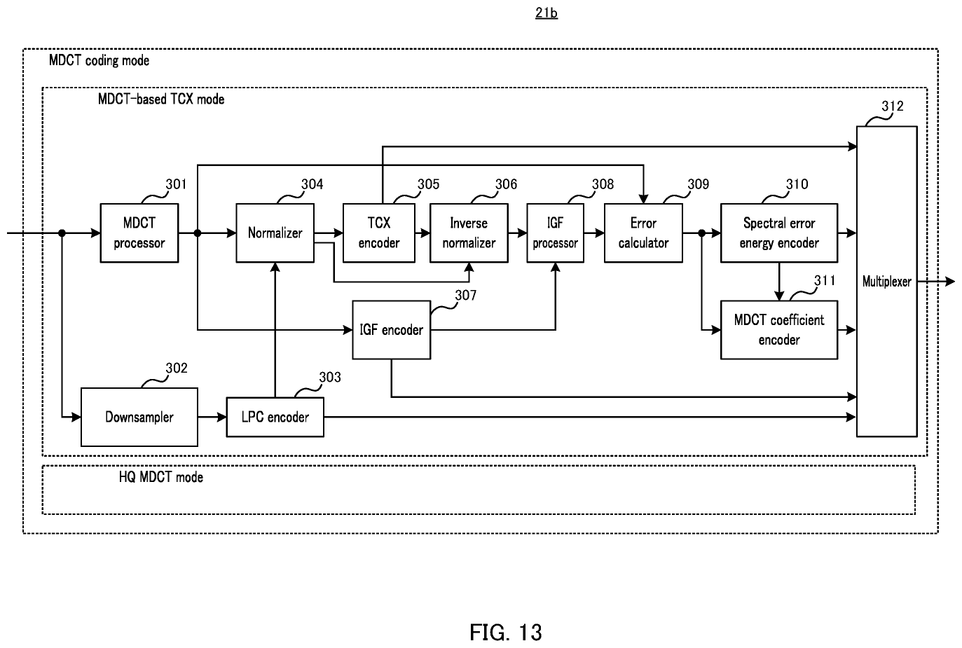

FIG. 13 is a block diagram illustrating an example of a configuration of EVS 13.2 kbps embedded encoder 21b in the MDCT-based TCX coding mode. Note that, hereinafter, EVS 13.2 kbps embedded encoder 21b in the MDCT-based TCX coding mode will also be referred to as “encoder 21b”.

For example, encoder 21b may encode an MDCT coefficient based on an LPC spectral envelope determined by a linear prediction analysis.

Encoder 21b may include, for example, MDCT processor 301, downsampler 302, LPC encoder 303, normalizer 304, TCX encoder 305, inverse normalizer 306, Intelligent Gap Filling (IGF) encoder 307, IGF processor 308, error calculator 309, spectral error energy encoder 310, MDCT coefficient encoder 311, and multiplexer 312.

In FIG. 13, a configuration processor that performs the coding in the core layer (corresponding to the coding circuitry in the core layer, for example) may include, for example, LPC encoder 303, normalizer 304, TCX encoder 305, and IGF encoder 307. Further, in FIG. 13, a configuration processor that performs the coding in the extension layer (corresponding to the coding circuitry in the extension layer, for example) may include, for example, inverse normalizer 306, IGF processor 308, error calculator 309, spectral error energy encoder 310, and MDCT coefficient encoder 311.

For example, an input signal such as the M signal of the MS stereo signal may be inputted to encoder 21b.

In FIG. 13, MDCT processor 301 may perform, for example, MDCT processing on the input signal. MDCT processor 301 may output, for example, the resulting MDCT coefficient (or MDCT spectrum) to normalizer 304, IGF encoder 307, and error calculator 309.

Downsampler 302 may downsample, for example, the input signal. Downsampler 302 may output, for example, the signal subjected to the downsampling (also referred to as the downsample signal) to LPC encoder 303.

For example, LPC encoder 303 may perform a linear prediction analysis on the signal inputted from downsampler 302, and quantize and encode a linear predictive coefficient (LPC). For example, LPC encoder 103 may output the quantized LPC (or decoded LPC) to normalizer 304 and output a coding result (for example, LPC coding information) to multiplexer 312.

Note that, downsampler 302 and LPC encoder 303 may be shared with the configuration of the LP-based coding mode (for example, downsampler 101 and LPC encoder 103 indicated in FIG. 4).

Normalizer 304 may normalize, for example, the MDCT coefficient inputted from MDCT processor 301. For example, normalizer 304 may determine the LPC spectral envelope from the quantized LPC inputted from LPC encoder 303, calculate an LPC shaping gain, and normalize the MDCT coefficient by using the calculated LPC shaping gain. For example, normalizer 304 may output the normalized MDCT coefficient to TCX encoder 305 and output the LPC shaping gain to inverse normalizer 306.

TCX encoder 305 may TCX encode, for example, the normalized MDCT coefficient inputted from normalizer 304. TCX encoder 305 may output a coding result (referred to as “TCX coding information”, for example) to multiplexer 312. Further, for example, TCX encoder 305 may decode the TCX coding information, perform noise filling, and then output the decoded normalized MDCT coefficient to inverse normalizer 306.

Inverse normalizer 306 may perform, for example, inverse normalization of the decoded normalized MDCT coefficient inputted from TCX encoder 305. For example, inverse normalizer 306 may perform inverse normalization of the decoded normalized MDCT coefficient by using the LPC shaping gain inputted from normalizer 304. Inverse normalizer 306 may output, for example, the decoded MDCT coefficient subjected to the inverse normalization to IGF processor 308.

For example, IGF encoder 307 may analyze an IGF parameter (in other words, a power spectrum analysis) based on the MDCT coefficient inputted from MDCT processor 301 and encode the IGF parameter. For example, IGF encoder 307 may output a coding result (referred to as “IGF coding information”, for example) to multiplexer 312 and output the IGF parameter to IGF processor 308.

IGF processor 308 may perform, for example, IGF processing (in other words, high-band-spectrum filling processing) on the decoded MDCT coefficient inputted from inverse normalizer 306 based on the IGF parameter inputted from IGF encoder 307. IGF processor 308 may output, for example, the decoded MDCT coefficient subjected to the IGF processing to error calculator 309.

Error calculator 309 may calculate, for example, a coding error (for example, an MDCT coefficient coding error or an error spectrum) in the core layer coding based on the MDCT coefficient (for example, a signal spectrum to be subjected to the core layer coding) inputted from MDCT processor 301 and the decoded MDCT coefficient (in other words, a decoded signal spectrum in the core layer coding) inputted from IGF processor 308 and subjected to the IGF processing. Error calculator 309 may output, for example, the MDCT coefficient coding error to spectral error energy encoder 310 and MDCT coefficient encoder 311.

For example, spectral error energy encoder 310 may calculate energy of the MDCT coefficient coding error inputted from calculator 309 in each of a plurality of sub-bands obtained by dividing a frequency band (referred to as the sub-band energy, for example), and quantize and encode the calculated sub-band energy. Spectral error energy encoder 310 may output, for example, a coding result (referred to as “spectral error energy coding information, for example) to multiplexer 312 and output the quantized sub-band energy to MDCT coefficient encoder 311.

MDCT coefficient encoder 311 may normalize, for example, the spectrum of the MDCT coefficient coding error inputted from error calculator 309 with the quantized sub-band energy inputted from spectral error energy encoder 310 to perform coding of the normalized error spectrum. MDCT coefficient encoder 311 may output, for example, a coding result (for example, “error spectrum coding information”) to multiplexer 312.

Note that, the sub-band widths in spectral error energy encoder 310 and MDCT coefficient encoder 311 may be equal. For example, in a case where a sub-band is designed with 20 bands, one band may be configured with 35 or 36 spectra for Transition sections and may be configured with 28 or 29 spectra for sections different from the Transition sections.

Multiplexer 312 may multiplex, for example, the LPC coding information inputted from LPC encoder 303, the TCX coding information inputted from TCX encoder 305, the IGF coding information inputted from IGF encoder 307, the spectral error energy coding information inputted from spectral error energy encoder 310, and the error spectrum coding information inputted from MDCT coefficient encoder 311. Multiplexer 312 may output, for example, a coding bitstream (for example, an EVS 13.2 kbps embedded coding bitstream) including the multiplexed signal to the transmission path or the storage apparatus.

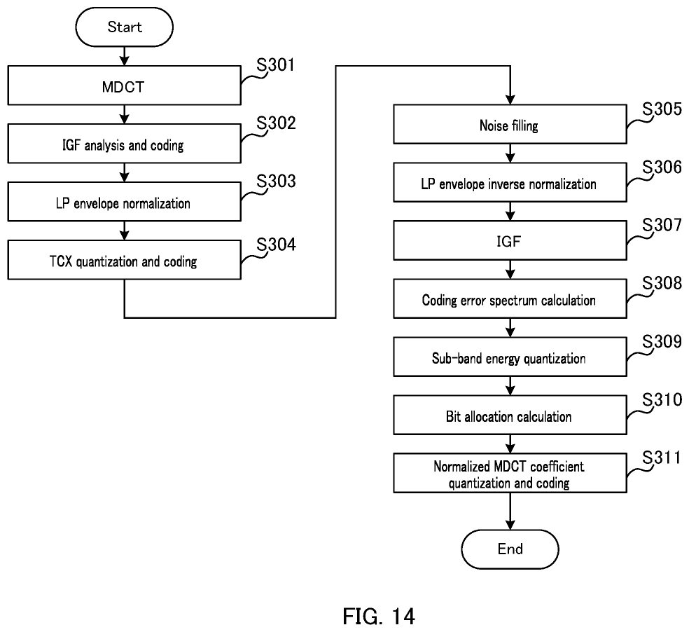

FIG. 14 is a flowchart illustrating an example of coding processing by encoder 21b.

In FIG. 14, encoder 21b (for example, MDCT processor 301) may perform, for example, the MDCT processing on the input signal (S301).

For example, encoder 21b (for example, IGF encoder 307) may analyze the IGF parameter based on the MDCT coefficient and encode the IGF parameter (S302).

For example, encoder 21b (for example, normalizer 304) may calculate the LPC shaping gain from the quantized LPC obtained by the LPC coding and use the LPC shaping gain to perform normalization of the MDCT coefficient (in other words, LP envelope normalization) (S303). Note that, the LPC shaping gain may correspond to the LPC spectral envelope obtained by subjecting the quantized LPC to DFT or the like, and a quantized LPC subjected to perceptual weighting may be used as the quantized LPC.

For example, encoder 21b (for example, TCX encoder 305) may quantize and encode the normalized MDCT coefficient (S304) and perform decoding and noise filling of the normalized MDCT coefficient (S305).

Encoder 21b (for example, inverse normalizer 306) may perform, for example, inverse normalization of the decoded normalized MDCT coefficient (S306).

For example, encoder 21b (for example, IGF processor 308) may perform the IGF processing on the decoded MDCT coefficient subjected to the inverse normalization and re-synthesize the decoded MDCT coefficient (S307).

Encoder 21b (for example, error calculator 309) may calculate, for example, an error (for example, an error spectrum) between the input MDCT coefficient and the decoded MDCT coefficient (S308).

Encoder 21b (for example, spectral error energy encoder 310) may quantize and encode, for example, the sub-band energy of the error spectrum (S309).

For example, encoder 21b (for example, MDCT coefficient encoder 311) may calculate bit allocation for each sub-band based on the sub-band energy of the error spectrum (S310) and quantize and encode the error spectrum based on the bit allocation (S311).

Further, for example, encoder 21b may update various memories based on a result of the coding processing.

<Example of Configuration of Decoder>

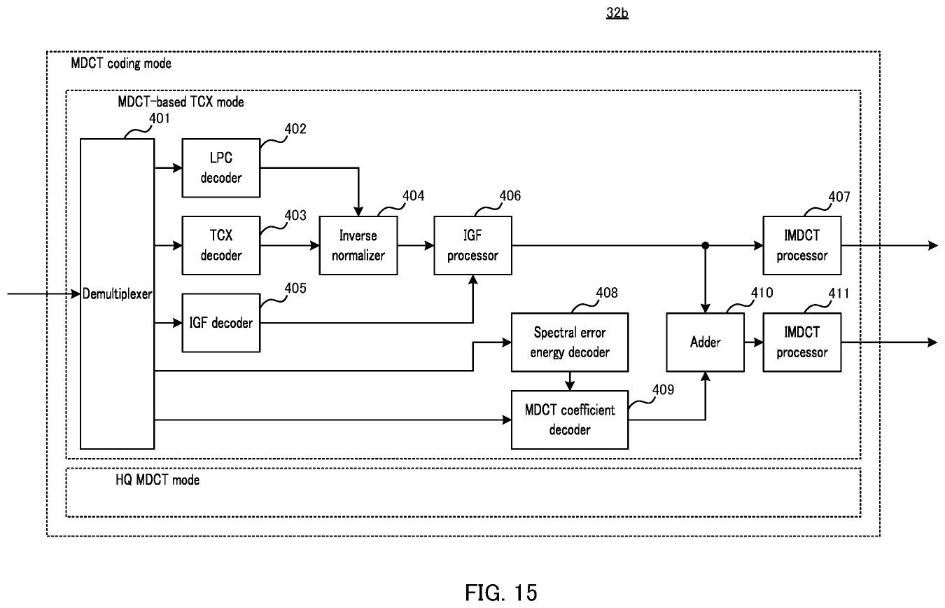

FIG. 15 is a block diagram illustrating an example of a configuration of EVS 13.2 kbps embedded decoder 32b in the MDCT-based TCX coding mode. Note that, hereinafter,

EVS 13.2 kbps embedded decoder 32b in the MDCT-based TCX coding mode will also be referred to as “decoder 32b”.

Decoder 32b may include, for example, demultiplexer 401, LPC decoder 402, TCX decoder 403, inverse normalizer 404, IGF decoder 405, IGF processor 406, Inverse Modified Discrete Cosine Transform (IMDCT) processor 407, spectral error energy decoder 408, MDCT coefficient decoder 409, adder 410, and IMDCT processor 411.

In FIG. 15, a configuration processor that performs the decoding in the core layer (corresponding to the decoding circuitry in the core layer, for example) may include, for example, LPC decoder 402, TCX decoder 403, inverse normalizer 404, IGF decoder 405, and IGF processor 406. Further, in FIG. 15, a configuration processor (corresponding to the decoding circuitry in the extension layer, for example) may include, for example, spectral error energy decoder 408, MDCT coefficient decoder 409, and adder 410.

Demultiplexer 401 may separate, for example, a coding bitstream inputted from the transmission path or the storage apparatus into LPC coding information, TCX coding information, IGF coding information, spectral error energy coding information, and error spectrum coding information. For example, demultiplexer 401 may output the LPC coding information to LPC decoder 402, output the TCX coding information to TCX decoder 403, output the IGF coding information to IGF decoder 405, output the spectral error energy coding information to spectral error energy decoder 408, and output the error spectrum coding information to MDCT coefficient decoder 409.

For example, LPC decoder 402 may decode the LPC coding information inputted from demultiplexer 401 and output the decoded quantized LPC to inverse normalizer 404.

For example, TCX decoder 403 may decode the TCX coding information inputted from demultiplexer 401, perform noise filling on the decoded normalized MDCT coefficient, and then output the decoded normalized MDCT coefficient to inverse normalizer 404.

For example, inverse normalizer 404 may convert the quantized LPC inputted from LPC decoder 402 to a LPC shaping gain and use the LPC shaping gain to perform inverse normalization of the decoded normalized MDCT coefficient inputted from TCX decoder 403. Inverse normalizer 404 may output, for example, the decoded MDCT coefficient subjected to the inverse normalization to IGF processor 406.

IGF decoder 405 may decode, for example, the IGF coding information inputted from demultiplexer 401 and output the IGF parameter to IGF processor 406.

IGF processor 406 may use, for example, the IGF parameter inputted from IGF decoder 405 to perform the IGF processing on the decoded MDCT coefficient inputted from inverse normalizer 404. IGF processor 406 may output, for example, the decoded MDCT coefficient subjected to the IGF processing to IMDCT processor 407 and adder 410.

For example, IMDCT processor 407 may convert the decoded MDCT coefficient inputted from IGF processor 406 to a time signal and output a decoded signal (for example, a decoded signal of EVS 13.2 kbps without the extension layer).

For example, spectral error energy decoder 408 may decode the spectral error energy coding information inputted from demultiplexer 401 and output the decoded quantized sub-band energy to MDCT coefficient decoder 409.

MDCT coefficient decoder 409 may decode, for example, the error spectrum coding information inputted from demultiplexer 401 to obtain an MDCT coefficient of the error spectrum. Further, for example, MDCT coefficient decoder 409 may multiply the MDCT coefficient of the error spectrum by the quantized sub-band energy inputted from spectral error energy decoder 408 to obtain an MDCT coefficient coding error spectrum. MDCT coefficient decoder 409 may output, for example, the MDCT coefficient coding error spectrum to adder 410.

Adder 410 may add, for example, the decoded MDCT coefficient (in other words, the decoded spectrum in the core layer) inputted from IGF processor 406 and the MDCT coefficient coding error spectrum (in other words, the coding error spectrum in the coding in the core layer) inputted from MDCT coefficient decoder 409. Adder 410 may output, for example, the decoded MDCT coefficient as the addition result to IMDCT processor 411.

For example, IMDCT processor 411 may convert the decoded MDCT coefficient inputted from adder 410 to a time signal and output a decoded signal (for example, a decoded signal in the entire embedded coding including the extension layer).

Note that, in FIG. 15, a configuration in which IMDCT processor 407 for a decoded signal of EVS 13.2 kbps without the extension layer and IMDCT processor 411 for a decoded signal in the entire embedded coding are separately provided has been described as an example, but the IMDCT processor may be configured to be shared between both the decoded signal of EVS 13.2 kbps without the extension layer and the decoded signal in the entire embedded coding. In this case, one of the output of IGF processor 406 and the output of adder 410 may be selected for the input to the IMDCT processor.

As an example, in a case where the IMDCT processor to be shared is IMDCT processor 411 (in other words, in a case where IMDCT processor 407 is not used), it may be configured such that the output of MDCT coefficient decoder 409 is turned ON/OFF. For example, in a case where the output of MDCT coefficient decoder 409 is OFF (output: zero), the output of IGF processor 406 is inputted to IMDCT processor 411. On the other hand, for example, in a case where the output of MDCT coefficient decoder 409 is ON, an addition result of the output of IGF processor 406 and the output of MDCT coefficient decoder 409 is inputted to IMDCT processor 411.

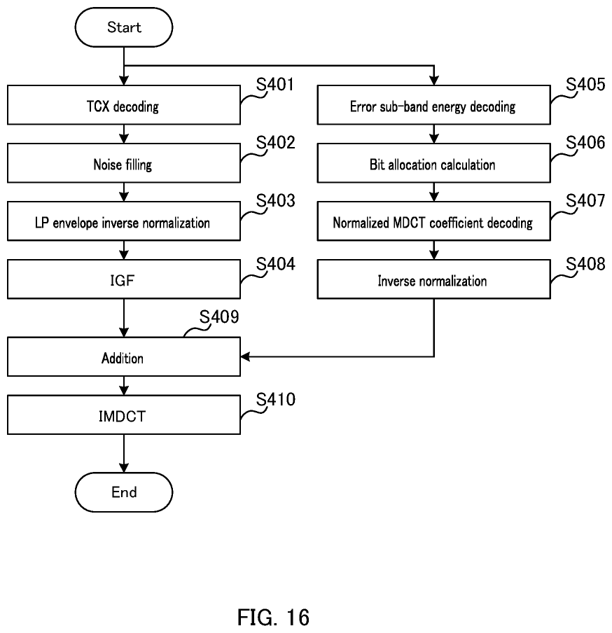

FIG. 16 is a flowchart illustrating an example of decoding processing by decoder 32b.

In FIG. 16, for example, decoder 32b (for example, TCX decoder 403) may decode the normalized MDCT coefficient (S401) and perform the noise filling (S402).

For example, decoder 32b (for example, LPC decoder 402 and inverse normalizer 404) may perform the LPC decoding and use the decoded LPC to perform the inverse normalization (or LP envelope inverse normalization) of the normalized MDCT coefficient (S403).

For example, decoder 32b (for example, IGF decoder 405 and IGF processor 406) may decode the IGF parameter and perform the IGF processing based on the IGF parameter (S404). The IGF processing makes it possible to obtain, for example, an EVS 13.2 kbps decoded MDCT coefficient.

For example, decoder 32b (for example, spectral error energy decoder 408) may decode the spectral error energy and decode the quantization energy of each sub-band (S405).

For example, decoder 32b (for example, MDCT coefficient decoder 409) may calculate the bit allocation of each sub-band based on the quantization energy of each sub-band (S406), decode the normalized MDCT coefficient of the error spectrum based on the bit allocation (S407), and multiple the decoded MDCT coefficient by the sub-band energy (in other words, performs scaling) to obtain a decoded MDCT coefficient coding error spectrum subjected to the scaling (S408).

Decoder 32b (for example, adder 410) may add, for example, the decoded MDCT coefficient of EVS 13.2 kbps and the decoded MDCT coefficient coding error spectrum to calculate the decoded MDCT coefficient (S409). For example, decoder 32b (for example, IMDCT processor 411) may convert the decoded MDCT coefficient to a time signal by the IMDCT to obtain a decoded signal (S410).

An example of the decoding processing by decoder 32b has been described above.

Thus, in a case where the coding mode used in the core layer is the MDCT-based TCX coding mode (for example, frequency domain coding or low-bit-rate transform coding), the coding method in the extension layer may be a coding method in the frequency domain. For example, in a case where the coding mode in the core layer is the MDCT-based TCX coding mode, encoder 21b may encode a coding error (in other words, an error spectrum) in the frequency domain (or frequency spectral domain or MDCT domain).

In other words, for example, in the extension in a low-bit-rate multimode coding scheme, encoder 21b additionally encodes, in the extension layer and in the frequency domain, a coding error in the core layer in the frequency domain in a frequency-domain coding mode. Further, for example, encoder 21b may perform the coding of the coding error in the frequency domain, in the extension layer, in the same frame as that of the core layer. Since the coding of the coding error is performed without conversion from a frequency domain signal to a time domain signal (in other words, decoding and reconstruction), for example, in the extension layer by the coding in the extension layer as described above, an additional algorithmic delay can be suppressed.

Further, in a mode in which an input signal (for example, the output of MDCT processor 301 indicated in FIG. 13) is used to encode a band extension parameter (for example, the IGF parameter), such as the MDCT-based TCX coding mode, the coding error in the core layer may be an error between a decoded spectrum (for example, the output of IGF processor 308) including a band extension component in the core layer coding and a spectrum (for example, the output of MDCT processor 301) of the input signal (for example, the M signal). Thus, for example, it is possible to improve coding performance for the coding error in the core layer with respect to the input signal.

Note that, although a case where the error (for example, the error spectrum) between the decoded spectrum (for example, the output of IGF processor 308) including the band extension coding component in the core layer and the input signal (for example, the MDCT coefficient) is calculated has been described in FIGS. 13 and 15, the present disclosure is not limited to this operation. For example, the error spectrum may be calculated from a decoded spectrum including no band extension coding component. In this case, for example, encoder 21b indicated in FIG. 13 may not include IGF processor 308. Further, in this case, for example, in decoder 32b indicated in FIG. 15, the output of inverse normalizer 404 (in other words, the output in a stage before IGF processor 406) may be inputted to adder 410 and the output of adder 410 may be inputted to IGF processor 406.

Further, an error spectrum that does not include, in addition to the band extension coding component, a component added by the noise filling may be calculated. In this case, error calculator 309 may calculate, for example, an error from the normalized MDCT coefficient outputted from normalizer 304 and the decoded normalized MDCT coefficient (not subjected to the noise filling) outputted from TCX encoder 305. In this case, for example, encoder 21b indicated in FIG. 13 may not include inverse normalizer 306 and IGF processor 308. Further, in this case, for example, in decoder 32b indicated in FIG. 15, adder 410 may be incorporated before the noise filling in TCX decoder 403, the output MDCT coefficient of MDCT coefficient decoder 409 may be added before the noise filling, and then the noise filling may be performed and the output thereof to inverse normalizer 404 may be performed.

Further, although the coding based on the sub-band energy has been described in FIGS. 13 and 15 as an example of the coding in the extension layer (for example, the coding of the error spectrum), the present disclosure is not limited thereto, and any other coding method may be used.

[LR-HQ Coding Mode]

<Example of Configuration of Encoder>

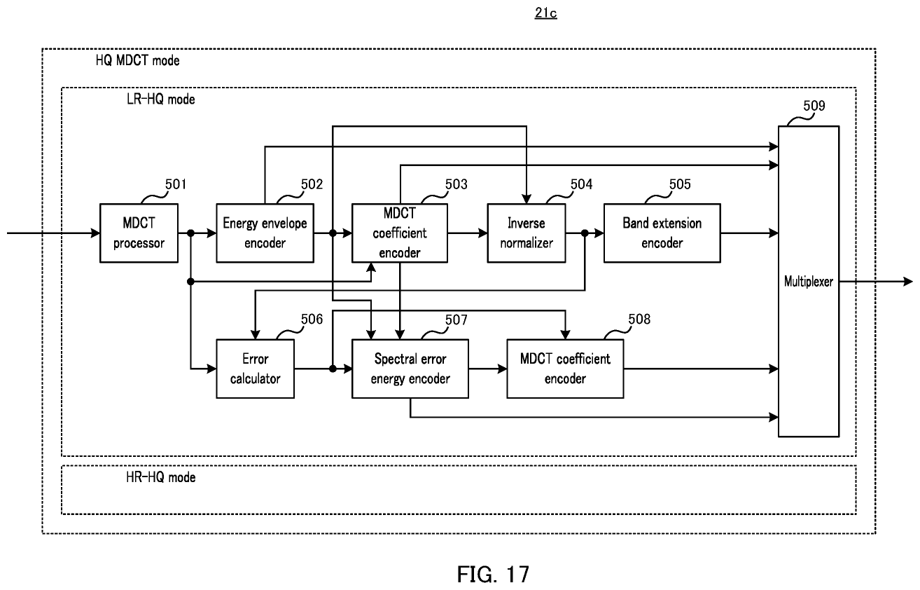

FIG. 17 is a block diagram illustrating an example of a configuration of EVS 13.2 kbps embedded encoder 21c in the LR-HQ coding mode of the MDCT coding mode. Note that, hereinafter, EVS 13.2 kbps embedded encoder 21c in the LR-HQ coding mode will also be referred to as “encoder 21c”.

Encoder 21c may encode, for example, energy of an MDCT coefficient for each sub-band (or band).

Encoder 21c may include, for example, MDCT processor 501, energy envelope encoder 502, MDCT coefficient encoder 503, inverse normalizer 504, band extension encoder 505, error calculator 506, spectral error energy encoder 507, MDCT coefficient encoder 508, and multiplexer 509.

In FIG. 17, a configuration processor that performs the coding in the core layer (corresponding to the coding circuitry in the core layer, for example) may include, for example, energy envelope encoder 502, MDCT coefficient encoder 503, inverse normalizer 504, and band extension encoder 505. Further, in FIG. 17, a configuration processor that performs the coding in the extension layer (corresponding to the coding circuitry in the extension layer, for example) may include, for example, error calculator 506, spectral error energy encoder 507, and MDCT coefficient encoder 508.

For example, an input signal such as the M signal may be inputted to encoder 21c.

In FIG. 17, MDCT processor 501 may perform, for example, the MDCT processing on the input signal. MDCT processor 501 may output, for example, the resulting MDCT coefficient (or MDCT spectrum) to energy envelope encoder 502, MDCT coefficient encoder 503, and error calculator 506.

For example, energy envelope encoder 502 may determine norm or energy (hereinafter referred to as sub-band energy) of the MDCT coefficient inputted from MDCT processor 501 in each of a plurality of sub-bands obtained by dividing a frequency band, and quantize and encode the sub-band energy. For example, energy envelope encoder 502 may output a coding result (referred to as “energy coding information”) to multiplexer 509 and output the quantized sub-band energy (or norm) to MDCT coefficient encoder 503, inverse normalizer 504, and spectral error energy encoder 507.

For example, MDCT coefficient encoder 503 may determine bit allocation with respect to the coding of the MDCT coefficient for each sub-band based on the quantized sub-band energy inputted from energy envelope encoder 502. Further, MDCT coefficient encoder 503 may normalize the MDCT coefficient inputted from MDCT processor 501 with the quantized sub-band energy. Further, for example, MDCT coefficient encoder 503 may quantize and encode the normalized MDCT coefficient for each sub-band based on the determined bit allocation. For example, MDCT coefficient encoder 503 may output a coding result (referred to as “MDCT coefficient coding information”, for example) to multiplexer 509 and output the quantized normalized MDCT coefficient to inverse normalizer 504.

Further, for example, MDCT coefficient encoder 503 may output information indicating a sub-band in which no MDCT coefficient is present (hereinafter referred to as “non-coded sub-band information”) to spectral error energy encoder 507 based on the coding result. Note that, information indicating the presence or absence of the MDCT coefficient in each sub-band may be used instead of the non-coded sub-band information.

Inverse normalizer 504 may perform, for example, inverse normalization processing on the quantized normalized MDCT coefficient inputted from MDCT coefficient encoder 503 based on the quantized sub-band energy inputted from energy envelope encoder 502. Inverse normalizer 504 may output, for example, the quantized MDCT coefficient subjected to the inverse normalization to band extension encoder 505 and error calculator 506.

For example, band extension encoder 505 may perform noise injection processing on the quantized MDCT coefficient inputted from inverse normalizer 504 to perform band extension coding. Band extension encoder 505 may output, for example, a coding result (referred to as “band extension coding information”, for example) to multiplexer 509.

Error calculator 506 may calculate, for example, a coding error (for example, an MDCT coefficient coding error or an error spectrum) in the core layer coding based on the MDCT coefficient inputted from MDCT processor 501 (in other words, the signal spectrum to be subjected to the core layer coding) and the quantized MDCT coefficient inputted from inverse normalizer 504 (in other words, the decoded signal spectrum in the core layer coding). Error calculator 506 may output, for example, the MDCT coefficient coding error to spectral error energy encoder 507 and MDCT coefficient encoder 508.

Note that, for example, in a case where there is a sub-band in which every quantized MDCT coefficient is zero (or equal to or less than a threshold value) at the time of the error calculation, error calculator 506 may output information indicating the sub-band (for example, the non-coded sub-band information) to spectral error energy encoder 507. For example, in a case where the inputted MDCT spectrum and the error spectrum are the same (or in a case where the difference therebetween is equal to or less than a threshold value), error calculator 506 may determine the sub-band as a sub-band in which every quantized MDCT coefficient is zero (for example, a non-coded sub-band).

Further, as described above, since the non-coded sub-band can be specified even by MDCT coefficient encoder 503, the non-coded sub-band information may be inputted from MDCT coefficient encoder 503 to error calculator 506. In this case, error calculator 506 may not calculate a coding error in the non-coded sub-band. In other words, error calculator 506 may calculate a coding error for a sub-band different from the non-coded sub-band.

For example, spectral error energy encoder 507 may calculate the sub-band energy of the error spectrum inputted from error calculator 506 in each of the plurality of sub-bands, and quantize and encode the calculated sub-band energy.

Further, for example, spectral error energy encoder 507 may quantize and encode the sub-band energy in a sub-band different from the non-coded sub-band based on the non-coded sub-band information inputted from MDCT coefficient encoder 503.

On the other hand, for example, spectral error energy encoder 507 may not perform coding processing for a non-coded sub-band among the plurality of sub-bands based on the non-coded sub-band information. Further, for example, spectral error energy encoder 507 may configure the sub-band energy of the non-coded sub-band to quantized sub-band energy of a sub-band corresponding to the non-coded sub-band inputted from energy envelope encoder 502.

Note that, the non-coded sub-band information (or information on determination of whether a decoded signal is present in a sub-band) may be inputted from MDCT coefficient encoder 503 or may be inputted from error calculator 506.

For example, spectral error energy encoder 507 may output a coding result (referred to as “spectral error energy coding information”, for example) to multiplexer 509 and output the quantized sub-band energy to MDCT coefficient encoder 508. Further, for example, spectral error energy encoder 507 may output information indicating the number of bits remaining (the number of redundant bits) by not performing coding of a non-coded sub-band to MDCT coefficient encoder 508.

MDCT coefficient encoder 508 may determine, for example, bit allocation for each sub-band based on the quantized sub-band energy inputted from spectral error energy encoder 507. For example, MDCT coefficient encoder 508 may determine the bit allocation for each sub-band based on the number of bits obtained by combining the number of bits allocated for MDCT coefficient coding in advance based on the information indicating the number of redundant bits inputted from spectral error energy encoder 507 with the number of redundant bits.

Further, for example, MDCT coefficient encoder 508 may normalize the MDCT coding error spectrum inputted from error calculator 506 with the quantized sub-band energy inputted from spectral error energy encoder 507.

Further, MDCT coefficient encoder 508 may encode, for example, the normalized MDCT coding error spectrum (also referred to as residual spectrum) based on the determined bit allocation. MDCT coefficient encoder 508 may output, for example, a coding result (referred to as “error spectrum coding information”, for example) to multiplexer 509.

Note that, the respective sub-band configurations to be configured to the coding of the MDCT coefficient of the input signal and the coding of the MDCT coefficient of the error spectrum may be the same. Configuring the sub-band configurations as the same may cause, for example, a case where the sub-band energy of the coding error spectrum may not be encoded. A decrease in sub-band energies of coding error spectra, which are to be encoded, can increase, for example, bit allocation to the coding of the MDCT coefficient and improve the coding quality.

Further, for example, the calculation of the sub-band energy of the coding error spectrum is not limited to the method of determining the difference between the sub-band energy of the input signal and the sub-band energy of the spectrum of the decoded signal. For example, encoder 21c may calculate an error spectrum between the spectrum of the input signal and the spectrum of the decoded signal and calculate the sub-band energy of the error spectrum to calculate the sub-band energy of the coding error spectrum.

Multiplexer 509 may multiplex, for example, the energy coding information inputted from energy envelope encoder 502, the MDCT coefficient coding information inputted from MDCT coefficient encoder 503, the band extension coding information inputted from band extension encoder 505, the spectral error energy coding information inputted from spectral error energy encoder 507, and the error spectrum coding information inputted from MDCT coefficient encoder 508. Multiplexer 509 may output, for example, a coding bitstream (for example, an EVS 13.2 kbps embedded coding bitstream) including the multiplexed signal to the transmission path or the storage apparatus.

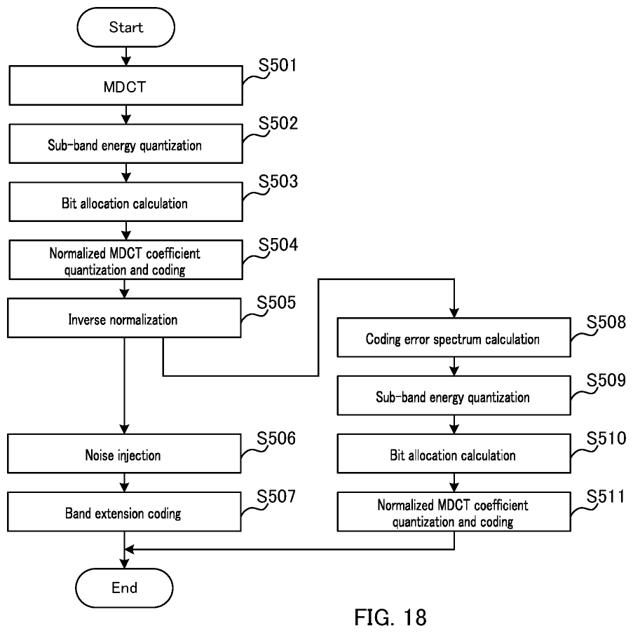

FIG. 18 is a flowchart illustrating an example of coding processing by encoder 21c.

In FIG. 18, encoder 21c (for example, MDCT processor 501) may perform, for example, the MDCT processing on an input signal (S501).

Encoder 21c (for example, energy envelope encoder 502) may quantize and encode, for example, the sub-band energy of the MDCT coefficient (S502).

For example, encoder 21c (for example, MDCT coefficient encoder 503) may calculate bit allocation for each sub-band with respect to MDCT coefficient coding (S503) and quantize and encode the normalized MDCT coefficient for each sub-band based on the bit allocation (S504).

Encoder 21c (for example, inverse normalizer 504) may perform, for example, the inverse normalization on the quantized sub-band energy (S505).

For example, encoder 21c (for example, band extension encoder 505) may perform noise injection processing on the quantized MDCT coefficient subjected to the inverse quantization (S506) and perform the band extension coding (S507).

Encoder 21c (for example, error calculator 506) may calculate, for example, the coding error spectrum (S508).

Encoder 21c (for example, spectral error energy encoder 507) may perform, for example, the sub-band energy coding (or sub-band energy quantization) of the coding error spectrum (S509).

For example, encoder 21c (for example, MDCT coefficient encoder 508) may calculate bit allocation for each sub-band of the coding error spectrum (S510) and quantize and encode the normalized coding error spectrum for each sub-band based on the bit allocation (S511).

Further, for example, encoder 21c may update various memories based on a result of the coding processing.

<Example of Configuration of Decoder>

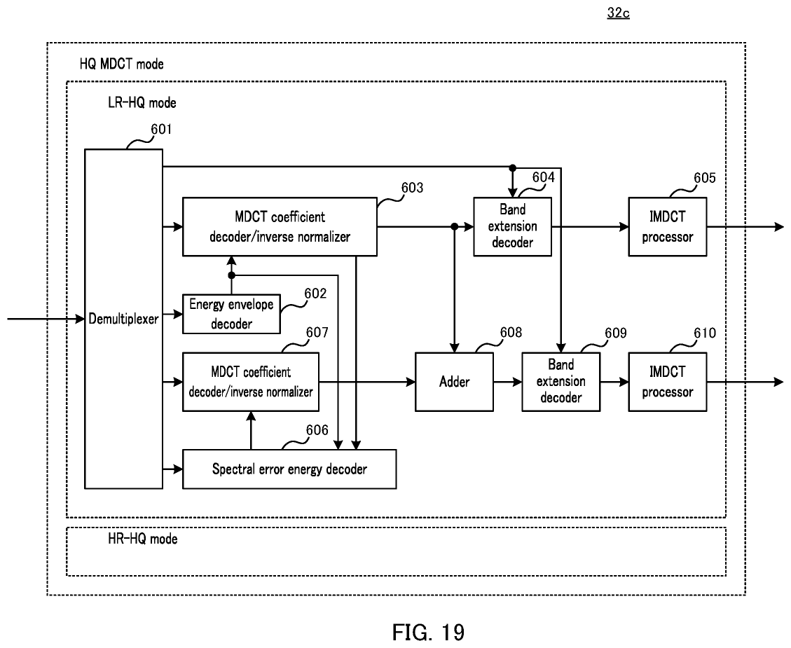

FIG. 19 is a block diagram illustrating an example of a configuration of EVS 13.2 kbps embedded decoder 32c in the LR-HQ coding mode. Note that, hereinafter, EVS 13.2 kbps embedded decoder 32c in the LR-HQ coding mode will also be referred to as “decoder 32c”.

Decoder 32c may include, for example, demultiplexer 601, energy envelope decoder 602, MDCT coefficient decoder/inverse normalizer 603, band extension decoder 604, IMDCT processor 605, spectral error energy decoder 606, MDCT coefficient decoder/inverse normalizer 607, adder 608, band extension decoder 609, and IMDCT processor 610.

In FIG. 19, a configuration processor that performs the decoding in the core layer (corresponding to the decoding circuitry in the core layer, for example) may include, for example, energy envelope decoder 602, MDCT coefficient decoder/inverse normalizer 603, and band extension decoders 604 and 609. Further, in FIG. 19, a configuration processor that performs the decoding in the extension layer (corresponding to the decoding circuitry in the extension layer, for example) may include, for example, spectral error energy decoder 606, MDCT coefficient decoder/inverse normalizer 607, and adder 608.

Demultiplexer 601 may separate, for example, a coding bitstream inputted from the transmission path or the storage apparatus into energy coding information, MDCT coefficient coding information, band extension coding information, spectral error energy coding information, and error spectrum coding information. For example, demultiplexer 601 may output the energy envelope coding information to energy envelope decoder 602, output the MDCT coefficient coding information to MDCT coefficient decoder/inverse normalizer 603, output the band extension coding information to band extension decoders 604 and 609, output the spectral error energy coding information to spectral error energy decoder 606, and output MDCT coefficient coding error spectrum information to MDCT coefficient decoder/inverse normalizer 607.

Energy envelope decoder 602 may decode, for example, the quantized sub-band energy information based on the energy coding information inputted from demultiplexer 601. Energy envelope decoder 602 may output, for example, the quantized sub-band energy information to MDCT coefficient decoder/inverse normalizer 603 and spectral error energy decoder 606.

MDCT coefficient decoder/inverse normalizer 603 may determine (in other words, decode), for example, bit allocation for MDCT coefficient quantization and encoding to each sub-band based on the sub-band energy indicated in the quantized sub-band energy information inputted from energy envelope decoder 602. Further, for example, MDCT coefficient decoder/inverse normalizer 603 may decode the MDCT coefficient coding information inputted from demultiplexer 601 based on the determined bit allocation to obtain a quantized MDCT coefficient. Further, for example, MDCT coefficient decoder/inverse normalizer 603 may perform inverse normalization of the quantized MDCT coefficient based on the quantized sub-band energy information inputted from energy envelope decoder 602 and output the resulting decoded MDCT coefficient to band extension decoder 604 and adder 608.

Further, for example, in a case where there is a sub-band in which no MDCT coefficient is present as a result of the decoding, MDCT coefficient decoder/inverse normalizer 603 may output non-coded sub-band information indicating the sub-band (for example, a non-coded sub-band) to spectral error energy decoder 606. Note that, information indicating the presence or absence of the MDCT coefficient in each sub-band may be used instead of the non-coded sub-band information.

For example, band extension decoder 604 may perform band extension processing (for example, decoding of an MDCT coefficient of a band to be extended) based on the band extension coding information inputted from demultiplexer 601 and the decoded MDCT coefficient inputted from MDCT coefficient decoder/inverse normalizer 603 and output the band-extended decoded MDCT coefficient to IMDCT processor 605.

For example, IMDCT processor 605 may convert the band-extended decoded MDCT coefficient inputted from band extension decoder 604 to a time domain signal and output a decoded signal (for example, a decoded signal of EVS 13.2 kbps without the extension layer).

For example, spectral error energy decoder 606 may decode the spectral error energy coding information inputted from demultiplexer 601 and output the quantized sub-band energy information of the coding error spectrum to MDCT coefficient decoder/inverse normalizer 607.

Note that, spectral error energy decoder 606 may configure, for example, the quantized sub-band energy information of the non-coded sub-band indicated in the non-coded sub-band information to information corresponding to the non-coded sub-band among the quantized sub-band energy information inputted from energy envelope decoder 602.

MDCT coefficient decoder/inverse normalizer 607 may determine (in other words, decode), for example, bit allocation for MDCT coefficient quantization and encoding to each sub-band based on the sub-band energy indicated in the quantized sub-band energy information inputted from spectral error energy decoder 606. Further, for example, MDCT coefficient decoder/inverse normalizer 607 may decode the error spectrum coding information inputted from demultiplexer 601 based on the determined bit allocation to obtain the quantized MDCT coefficient of each sub-band. Further, for example, MDCT coefficient decoder/inverse normalizer 607 may perform inverse normalization of the quantized MDCT coefficient based on the quantized sub-band energy and output the decoded MDCT coefficient coding error spectrum to adder 608.

Adder 608 may add, for example, the decoded MDCT coefficient (in other words, the decoded spectrum in the core layer) inputted from MDCT coefficient decoder/inverse normalizer 603 and the decoded MDCT coefficient coding error spectrum (in other words, the coding error spectrum in the coding in the core layer) inputted from MDCT coefficient decoder/inverse normalizer 607. For example, adder 608 may perform noise injection processing on the MDCT coefficient (spectrum) as the addition result, and output the MDCT coefficient subjected to the noise injection processing to band extension decoder 609.

For example, in a case where no decoded spectrum is present in the sub-band, band extension decoder 609 may perform band extension processing (for example, decoding of the MDCT coefficient of a band to be extended) based on the band extension coding information inputted from demultiplexer 601 and the decoded MDCT coefficient inputted from adder 608 and output the decoded MDCT coefficient subjected to the band extension to IMDCT processor 610. For example, in a case where a decoded spectrum is present in the sub-band, band extension decoder 609 may not perform the band extension processing using the band extension coding information.

For example, IMDCT processor 610 may convert the MDCT coefficient inputted from band extension decoder 609 to a time signal and output a decoded signal (for example, a decoded signal in the entire embedded coding including the extension layer).

Note that, although a configuration in which band extension decoder 604 and IMDCT processor 605 for a decoded signal of EVS 13.2 kbps without the extension layer and band extension decoder 609 and IMDCT processor 610 for a decoded signal in the entire embedded coding are separately provided has been described in FIG. 19 as an example, the band extension decoder and the IMDCT processor may be configured to be shared between both the decoded signal of EVS 13.2 kbps without the extension layer and the decoded signal in the entire embedded coding. In this case, one of the output of MDCT coefficient decoder/inverse normalizer 603 and the output of adder 608 may be selected for the input to band extension decoder.

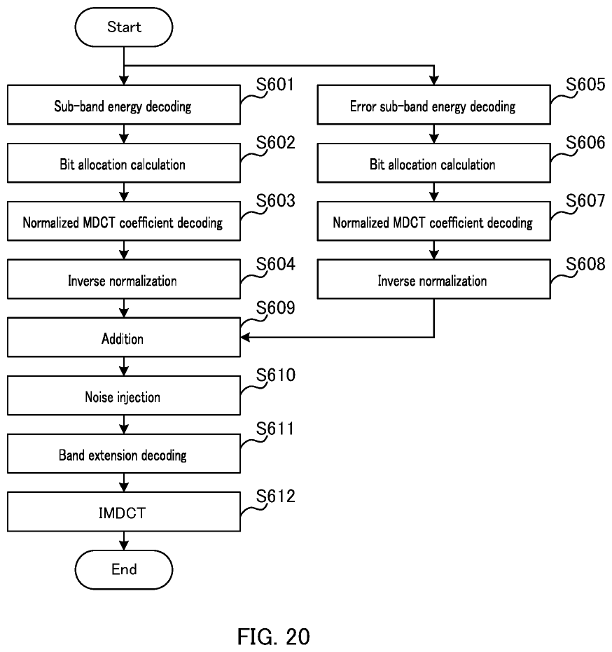

FIG. 20 is a flowchart illustrating an example of decoding processing by decoder 32c.

In FIG. 20, decoder 32c (for example, energy envelope decoder 602) may perform, for example, the decoding of the quantized sub-band energy of the MDCT coefficient (S601).

For example, decoder 32c (for example, MDCT coefficient decoder/inverse normalizer 603) may determine bit allocation for each sub-band based on the quantization sub-band energy of the MDCT coefficient (S602), performs decoding of the normalized MDCT coefficient based on the bit allocation (S603), and perform the inverse normalization of the normalized MDCT coefficient by using the quantization sub-band energy to obtain the decoded MDCT coefficient (S604).

Further, decoder 32c (for example, spectral error energy decoder 606) may perform, for example, the decoding of the quantized sub-band energy of the MDCT coding error spectrum (S605).

For example, decoder 32c (for example, MDCT coefficient decoder/inverse normalizer 607) may determine bit allocation for each sub-band based on the quantized sub-band energy of the MDCT coding error spectrum (S606), decode the normalized MDCT coefficient of the MDCT coding error spectrum based on the bit allocation (S607), and perform inverse normalization of the normalized MDCT coefficient of the MDCT coding error spectrum by using the quantized sub-band energy of the MDCT coding error spectrum to obtain the decoded MDCT coefficient of the MDCT coding error spectrum (S608).

For example, decoder 32c (for example, adder 608) may perform the addition processing of the decoded MDCT coefficient and the decoded MDCT coefficient of the MDCT coding error spectrum (S609), and perform the noise injection (S610).

Further, for example, in a case where no decoded spectrum is present in a sub-band to be decoded (in other words, in a case where no encoded spectrum is present and the decoding is performed only by a sub-band of a zero spectrum or the EVS 13.2 kbps codec), decoder 32c (for example, band extension decoder 604) may perform the band extension decoding processing (S611).

Decoder 32c (for example, IMDCT processor 605 or IMDCT processor 610) may perform, for example, the IMDCT on the MDCT coefficient (S612) after the band extension decoding processing (after the processing in S611).

An example of the decoding processing by decoder 32b has been described above.

Thus, in a case where the coding mode used in the core layer is the LR-HQ coding mode (for example, frequency domain coding or low-bit-rate transform coding), the coding method in the extension layer may be a coding method in the frequency domain. For example, in a case where the coding mode in the core layer is the LR-HQ coding mode, encoder 21c may encode a coding error (in other words, an error spectrum) in the frequency domain (or frequency spectral domain or MDCT domain).

In other words, for example, in the extension in a low-bit-rate multimode coding scheme, encoder 21c additionally encodes, in the extension layer and in the frequency domain, a coding error in the core layer in the frequency domain in a frequency-domain coding mode. Further, for example, encoder 21c may perform the coding of the coding error in the frequency domain, in the extension layer, in the same frame as that of the core layer. Since the coding of the coding error is performed without conversion from a frequency domain signal to a time domain signal (in other words, decoding and reconstruction), for example, in the extension layer by the coding in the extension layer as described above, an additional algorithmic delay can be suppressed.

Further, in the LR-HQ coding mode, the sub-band configurations may be the same between the core layer and the extension layer. Further, for example, encoder 21c and decoder 32c may use the quantized sub-band energy of the MDCT coefficient in the core layer for the coding and decoding in the extension layer (for example, configuration of quantized sub-band energy in a non-coded sub-band). In other words, energy envelope-related information may be shared between the core layer and the extension layer. Thus, it is possible to improve efficiency of the coding and decoding in the extension layer.

Further, in a mode in which a decoded spectrum (for example, the output of inverse normalizer 504 indicated in FIG. 17) is used to encode a spectrum in the extension band, such as the LR-HQ coding mode, a coding error in the core layer may be an error between a decoded spectrum (for example, the output of inverse normalizer 504) including no band extension component in the core layer coding and a spectrum (for example, the output of MDCT processor 501) of the input signal (for example, the M signal). Thus, for example, even in a case where the coding performance of the band extension coding (in other words, coding of a high-band spectrum) by band extension encoder 505 is low, the coding performance of the coding error can be improved.

Note that, although a case where an error (for example, error spectrum) between the decoded spectrum (for example, the output of inverse normalizer 504) including no band extension coding component in the core layer and the input signal (for example, the MDCT coefficient) is calculated has been described in FIGS. 17 and 19, the present disclosure is not limited to this operation. For example, the error spectrum may be calculated from a decoded spectrum including a band extension coding component. In this case, for example, in encoder 21c indicated in FIG. 17, the output of band extension encoder 505 may be inputted to error calculator 506. Further, in this case, for example, in decoder 32c indicated in FIG. 19, the output of band extension decoder 604 may be inputted to adder 608.

Further, although, the coding based on the sub-band energy has been described in FIGS. 17 and 19 as an example of the coding in the extension layer (for example, the coding of the error spectrum), the present disclosure is not limited thereto, and any other coding method may be used. The sub-band energy may be the sub-band norm or the sub-band amplitude.

The coding processing and the decoding processing in each of the three coding modes in the core layer have been described above.

As described above, for example, encoder 21 and decoder 32 may determine, the coding mode in the extension layer based on the coding mode (for example, one of the LP-based coding mode, the MDCT-based TCX coding mode, and the LR-HQ coding mode) in the core layer. For example, in encoder 21 and decoder 32, extension layers that differ between the time-domain coding mode and the frequency-domain coding mode may be added.

For example, in a case where the coding mode in the core layer is the time-domain coding mode such as the LP-based coding mode, encoder 21 and decoder 32 may configure a coding mode (or codec) (for example, the LD-CELP) independent of a plurality of coding modes (or sub-modes) in the time-domain coding mode in the extension layer. Thus, the coding in the extension layer can be performed uniformly for each sub-mode independently of the sub-modes in the time-domain coding mode in the core layer so that complication of the coding in the extension layer coding can be suppressed, for example. Further, for example, an additional algorithmic delay in the coding in the extension layer can be suppressed by a coding mode such as the LD-CELP.

On the other hand, for example, in a case where the coding mode in the core layer is the frequency-domain coding mode such as the MDCT-based TCX coding mode and the LR-HQ coding mode, encoder 21 and decoder 32 may encode and decode, in the extension layer, an error spectrum in the frequency domain. Thus, for example, the coding in the frequency domain can be performed even in the extension layer based on the coding information in the frequency domain in the core layer so that an additional delay in the coding in the extension layer can be suppressed.

Thus, switching the coding in the extension layer in accordance with the coding mode in the core layer makes it possible to improve coding performance in scalable coding with low-bit-rate speech/audio signal coding as a core with respect to the MS stereo signal. Accordingly, the present embodiment makes it possible to realize, for example, coding and decoding with a monaural low-bit-rate codec and scalability by using, in M channel coding of the MS stereo signal, the scalable coding with the low-bit-rate speech/audio signal coding as a core. In other words, the present embodiment makes it possible to realize coding and decoding processing of a high-quality stereo signal by adding coding information on extension layer coding (or an extension codec) of scalable coding with respect to the M signal of the MS stereo signal and coding information on a codec for the S signal to coding information on low-bit-rate multimode coding with respect to the M signal.

[Example of Configuration of Simulcast Coding/Scalable Coding Hybrid System]

For example, there is a coding system technique that switches between scalable coding (embedded coding) and simulcast coding (see, for example, Patent Literature (hereinafter referred to as “PTL”) 1).

<Example of Configuration of Hybrid Coding System>

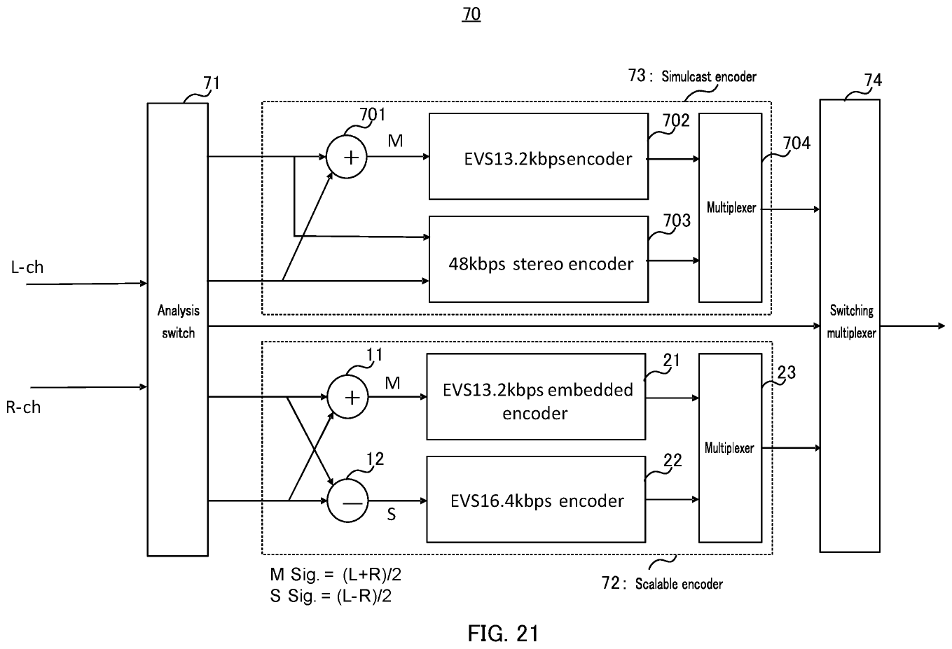

FIG. 21 illustrates an example of a configuration of a hybrid coding system according to an exemplary embodiment of the present disclosure.

Hybrid coding system 70 indicated in FIG. 21 includes analysis switch 71 (corresponding to an analyzer, for example), scalable encoder 72, simulcast encoder 73, and switching multiplexer 74. Hybrid coding system 70 uses scalable encoder 72 and simulcast encoder 73 by switching, for example.

Analysis switch 71 receives an input of a stereo signal (for example, an L-channel (left channel) signal and an R-channel (right channel) signal) and performs an analysis based on channel correlation. Analysis switch 71 may output, for example, the stereo signal to one of scalable encoder 72 and simulcast encoder 73 based on a result of the analysis. In other words, analysis switch 71 may switch, for example, an output destination of the stereo signal between scalable encoder 72 and simulcast encoder 73 based on the result of the analysis. Further, analysis switch 71 may output, for example, switching information indicating the output destination of the stereo signal to switching multiplexer 74.

For example, in the analysis based on the channel correlation, analysis switch 71 may calculate cross-correlation between the L-channel signal and the R-channel signal to determine whether a maximum value of the cross-correlation exceeds a threshold value, and may determine whether a magnitude or energy of a cross spectrum of the L-channel and the R-channel exceeds a threshold value.

For example, in a case where a channel correlation-related value (for example, the maximum value or the magnitude or energy of the cross spectrum) exceeds the threshold in the analysis based on the channel correlation, the scalable (or embedded) coding scheme according to an exemplary embodiment of the present disclosure may be applied because the inter-channel correlation is high and coding performance by an MS stereo coding scheme is likely to be high. For example, in a case where the channel correlation-related value exceeds the threshold value, analysis switch 71 may switch the output destination of the stereo signal to scalable encoder 72.

On the other hand, for example, in a case where the channel correlation-related value is equal to or less than the threshold in the analysis based on the channel correlation, the scalable coding scheme according to an exemplary embodiment of the present disclosure may not be applied because the inter-channel correlation is low and high performance is hardly obtained in the MS stereo coding scheme. In this case, for example, a simulcast coding scheme of stereo coding and EVS coding in consideration of coding of a stereo signal with low inter-channel correlation as well may be applied. For example, in a case where the channel correlation-related value is equal to or less than the threshold, analysis switch 71 may switch the output destination of the stereo signal to simulcast encoder 73.

Further, for example, in a case where there is a phase difference between a signal of the L-channel and a signal of the R-channel and the cross-correlation increases by correcting the phase difference, analysis switch 71 may output the stereo signal by performing processing of deviating (shifting) at least one of phases in the L-channel and the R-channel by a phase difference with the maximum cross-correlation. In a case where a phase of the stereo signal is deviated, analysis switch 71 may encode phase information and perform multiplexing to coding information.

Scalable encoder 72 may be the same scalable encoder as, for example, coding system 20 indicated in FIG. 2. In FIG. 21, the configurations included in scalable encoder 72 are denoted by the same numbers as the configurations included in coding system 20 indicated in FIG. 2 and descriptions of the configurations and operations thereof will be omitted. For example, scalable encoder 72 may receive an input of the stereo signal from analysis switch 71 and output a coding result to switching multiplexer 74.

Simulcast encoder 73 includes, for example, downmixer (adder) 701 that downmixes the stereo signal, EVS encoder 702 (for example, an EVS 13.2 kbps encoder) that encodes a monaural signal obtained by downmixing, stereo encoder 703 (for example, a 48 kbps stereo encoder) that encodes the stereo signal, and multiplexer 704 that multiplexes the coding information.

For example, adder 701 adds (downmixes) the L-channel signal and the R-channel signal of the inputted stereo signal to generate monaural signal M, and outputs monaural signal M to EVS encoder 702 (13.2 kbps).

For example, EVS encoder 702 performs coding of monaural signal M inputted from adder 701, and outputs a coding result to multiplexer 704. For example, EVS encoder 702 may perform the same coding as the coding in the core layer of the EVS 13.2 kbps embedded encoder or may perform the coding processing at 13.2 kbps indicated in NPL 1.

For example, stereo encoder 703 performs coding of the stereo signal inputted from analysis switch 71, and outputs a coding result to multiplexer 704. For example, stereo encoder 703 may perform coding processing at 48 kbps and may perform coding processing such that the bit rate is the same as or comparable to that of the scalable encoder together with EVS coding at 13.2 kbps.

For example, multiplexer 704 may multiplex the coding information with 13.2 kbps inputted from EVS encoder 702 and the coding information (for example, coding information with 48 kbps) inputted from stereo encoder 703 and output the multiplexed coding information to switching multiplexer 74.

An example of a configuration of simulcast encoder 73 has been described above.

In hybrid coding system 70, for example, switching multiplexer 74 may multiplex the switching information inputted from analysis switch 71 and the coding result inputted from either scalable encoder 72 or simulcast encoder 73 in accordance with the switching information and output the multiplexed switching information and coding result as a bitstream to the transmission path or the storage medium.

<Example of Configuration of Hybrid Decoding System>

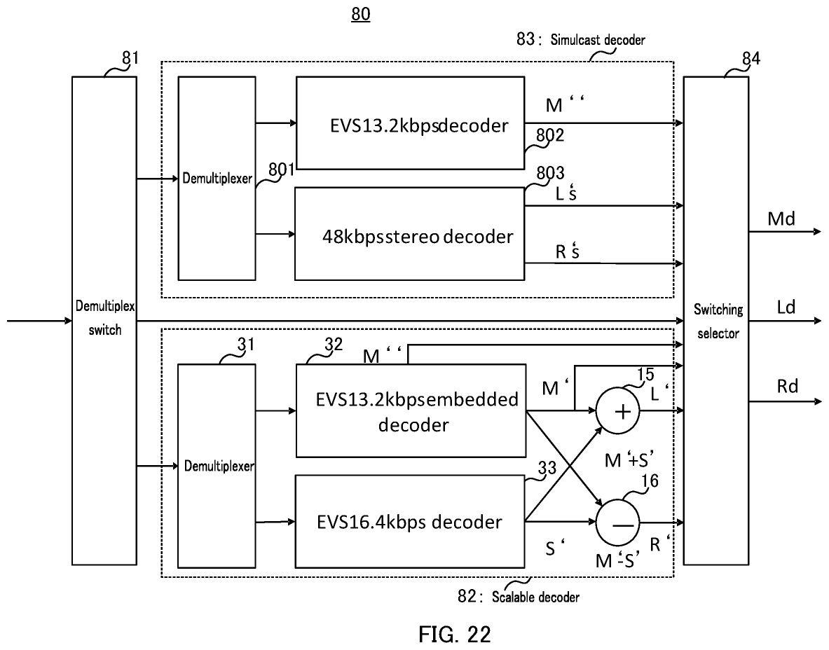

FIG. 22 illustrates an example of a configuration of a hybrid decoding system according to an exemplary embodiment of the present disclosure.

Hybrid decoding system 80 indicated in FIG. 22 includes demultiplex switch 81, scalable decoder 82, simulcast decoder 83, and switching selector 84. Hybrid decoding system 80 uses scalable decoder 82 and simulcast decoder 83 by switching, for example.

For example, demultiplex switch 81 may receive an input of a bitstream from the transmission path or the storage medium, separate multiplexed information, and output other coding information to one of scalable decoder 82 and simulcast decoder 83 based on the separated and decoded switching information.

Scalable decoder 82 may be the same scalable decoder as, for example, decoding system 30 indicated in FIG. 3. In FIG. 22, the configurations included in scalable decoder 82 are denoted by the same numbers as the configurations included in decoding system 30 indicated in FIG. 3 and descriptions of the configurations and operations thereof will be omitted.

However, for example, EVS 13.2 kbps embedded decoder 32 may output, in addition to decoded monaural signal M′, M″ which is a decoded monaural signal including solely the core layer. Further, the decoded monaural signal outputted from EVS 13.2 kbps embedded decoder 32 may be one of M′ and M″.

For example, scalable decoder 82 may decode the coding bitstream inputted from demultiplex switch 81 and output decoded monaural signals M′ and M″ and decoded stereo signal L′ and R′ to switching selector 84.

Simulcast decoder 83 includes, for example, demultiplexer 801, EVS decoder 802 (for example, an EVS 13.2 kbps decoder), and stereo decoder 803 (for example, a 48 kbps stereo decoder).

For example, demultiplexer 801 may separate the bitstream inputted from demultiplex switch 81 into an EVS coding bitstream and a stereo coding bitstream, output the EVS coding bitstream to EVS decoder 802, and output the stereo coding bitstream to stereo decoder 803.

For example, EVS decoder 802 may decode decoded monaural signal M″ from the EVS coding bitstream inputted from demultiplexer 801 and output decoded monaural signal M″ to switching selector 84.

For example, stereo decoder 803 may decode decoded stereo signals L's and R's from the stereo coding bitstream inputted from demultiplexer 801 and output decoded stereo signals L's and R's to switching selector 84.

An example of a configuration of simulcast decoder 83 has been described above.

In hybrid decoding system 80, for example, switching selector 84 may receive inputs of the decoded monaural signal and the decoded stereo signals from either scalable decoder 82 or simulcast decoder 83 in accordance with the switching information inputted from demultiplex switch 81 and output decoded monaural signal Md and decoded stereo signals Ld and Rd, three of which are final signals, to a sound output device via a D/A converter or the like.

As described above, in hybrid coding system 70, analysis switch 71 calculates cross-correlation between channels in an input signal (for example, a stereo signal), switches an output destination of the input signal to scalable encoder 72 in a case where a maximum value of the cross-correlation (or a magnitude or energy of a cross spectrum) exceeds a threshold value, and switches the output destination of the input signal to simulcast encoder 73 in a case where the maximum value of the cross-correlation is equal to or less than the threshold value. Hybrid coding system 70 can switch whether MS stereo coding is applied in accordance with the channel correlation of the input signal by switching the output destination of the input signal described above so that coding performance can be improved.

An example of a configuration of the hybrid coding system has been described above.

An embodiment of the present disclosure has been described above.

Note that, the codec scheme is not limited to the EVS 13.2 kbps codec and the EVS 16.4 kbps codec, but may be other codec schemes.

Further, the time-domain coding mode is not limited to, for example, the LP-based coding mode, but may be any other coding mode in the time domain. Further, the frequency-domain coding mode is not limited to, for example, the MDCT-based TCX coding mode and the LR-HQ modes, but may be any other coding mode in the frequency domain.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a Field Programmable Gate Array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

An encoder according to an exemplary embodiment of the present disclosure includes: first coding circuitry, which, in operation, encodes an input signal by selectively using, in a core layer, coding in a time domain or a frequency domain in accordance with a characteristic of the input signal; and second coding circuitry, which, in operation, encodes a coding error by the first coding circuitry by using, in an extension layer with respect to the core layer, a coding method corresponding to a domain type of the coding used in the core layer.

In an exemplary embodiment of the present disclosure, in a case where the coding used in the core layer is the coding in the time domain, the coding method in the extension layer is independent of a plurality of candidate coding methods in the coding in the time domain.

In an exemplary embodiment of the present disclosure, the coding method in the extension layer is a Low Delay-Code Excited Linear Prediction (LD-CELP) coding mode.

In an exemplary embodiment of the present disclosure, in a case where the coding used in the core layer is the coding in the frequency domain, the coding method in the extension layer is a coding method in the frequency domain.

In an exemplary embodiment of the present disclosure, the coding error is an error between a decoded spectrum including a band extension component in the coding in the core layer and a spectrum of the input signal.

In an exemplary embodiment of the present disclosure, the coding error is an error between a decoded spectrum including no band extension component in the coding in the core layer and a spectrum of the input signal.

In an exemplary embodiment of the present disclosure, the input signal is a sum signal indicating a sum of a left-channel signal and a right-channel signal which configure a stereo signal.

In an exemplary embodiment of the present disclosure, the first coding circuitry includes Linear Predictive Coding (LPC) coding circuitry, and the encoder further includes: first pre-emphasis circuitry, which, in operation, performs first pre-emphasis processing on the input signal to the LPC coding circuitry; and second pre-emphasis circuitry, which, in operation, performs second pre-emphasis processing on the input signal to the second coding circuitry, where the second pre-emphasis processing differs from the first pre-emphasis processing in emphasis intensity.

In an exemplary embodiment of the present disclosure, the encoder further includes: error calculation circuitry, which, in operation, calculates the coding error by the first coding circuitry; and de-emphasis circuitry, which, in operation, performs de-emphasis processing on a signal inputted to the error calculation circuitry.

A decoder according to an exemplary embodiment of the present disclosure includes: first decoding circuitry, which, in operation, decodes coding information of an input signal encoded by selectively using, in a core layer, coding in a time domain or a frequency domain in accordance with a characteristic of the input signal; and second decoding circuitry, which, in operation, decodes coding information of a coding error by the coding in the core layer, where the coding error is encoded by using, in an extension layer with respect to the core layer, a coding method corresponding to a domain type of the coding used in the core layer.

In an exemplary embodiment of the present disclosure, the decoder further includes: first de-emphasis circuitry, which, in operation, performs first de-emphasis processing on a decoded signal outputted from the first decoding circuitry; and second de-emphasis circuitry, which, in operation, performs second de-emphasis processing on a decoded signal outputted from the second decoding circuitry.

A coding method according to an exemplary embodiment of the present disclosure includes: encoding, by an encoder, an input signal by selectively using, in a core layer, coding in a time domain or a frequency domain in accordance with a characteristic of the input signal; and encoding, by the encoder, a coding error by the coding in the core layer by using, in an extension layer with respect to the core layer, a coding method corresponding to a domain type of the coding used in the core layer.

A decoding method according to an exemplary embodiment of the present disclosure includes: decoding, by a decoder, coding information of an input signal encoded by selectively using, in a core layer, coding in a time domain or a frequency domain in accordance with a characteristic of the input signal; and decoding, by the decoder, coding information of a coding error by the coding in the core layer, where the coding error is encoded by using, in an extension layer with respect to the core layer, a coding method corresponding to a domain type of the coding used in the core layer.

A hybrid coding system according to an exemplary embodiment of the present disclosure includes: the encoder; a simulcast encoder; and an analyzer that performs an analysis based on channel correlation with respect to the input signal. The analyzer calculates cross-correlation between channels in the input signal. The analyzer switches an output destination of the input signal to the encoder in a case where a maximum value of the cross-correlation exceeds a threshold value. The analyzer switches the output destination of the input signal to the simulcast encoder in a case where the maximum value of the cross-correlation is equal to or less than the threshold value.

The disclosures of Japanese Patent Application No. 2020-117124, filed on Jul. 7, 2020, Japanese Patent Application No. 2020-173259, filed on Oct. 14, 2020, and Japanese Patent Application No. 2020-181197, filed on Oct. 29, 2020, each including the specification, drawings, and abstract, are incorporated herein by reference in their entirety.

### INDUSTRIAL APPLICABILITY

An exemplary embodiment of the present disclosure is useful for a coding system or the like.

### REFERENCE SIGNS LIST

1 MS stereo coding/decoding system
11, 15, 209, 410, 608, 701 Adder
12, 16 Subtractor
13 EVS 13.2 kbps embedded encoder/decoder
14 EVS 16.4 kbps encoder/decoder
20 Coding system
21, 21a, 21a-1, 21a-2, 21a-3, 21b, 21c EVS 13.2 kbps embedded encoder
22 EVS 16.4 kbps encoder
23, 109, 312, 509, 704 Multiplexer
30 Decoding system
31, 201, 401, 601, 801 Demultiplexer
32, 32a, 32a-1, 32a-2, 32b, 32c EVS 13.2 kbps embedded decoder
33 EVS 16.4 kbps decoder
70 Hybrid coding system
71 Analysis switch
72 Scalable encoder
73 Simulcast encoder
74 Switching multiplexer
80 Hybrid decoding system
81 Demultiplex switch
82 Scalable decoder
83 Simulcast decoder
84 Switching selector
101, 302 Downsampler
102 Signal classifier
103, 303 LPC encoder
104 Excitation source encoder
105, 204 Synthesis filter
106, 309, 506 Error calculator
107 LD-CELP encoder
108 High-band encoder
151 Downsampling pre-emphasizer
152, 152-1, 152-2, 251, 255 De-emphasizer
153, 252 Pre-emphasizer
253, 254 De-emphasis upsampler
202, 402 LPC decoder
203 Excitation source decoder
205, 210 Upsampler
206 High-band decoder
207, 211 Synthesis filter bank
208 LD-CELP decoder
301, 501 MDCT processor
304 Normalizer
305 TCX encoder
306, 404, 504 Inverse normalizer
307 IGF encoder
308, 406 IGF processor
310, 507 Spectral error energy encoder
311, 503, 508 MDCT coefficient encoder
403 TCX decoder
405 IGF decoder
407, 411, 605, 610 IMDCT processor
408, 606 Spectral error energy decoder
409 MDCT coefficient decoder
502 Energy envelope encoder
5 505 Band extension encoder
602 Energy envelope decoder
603, 607 MDCT coefficient decoder/inverse normalizer
604, 609 Band extension decoder
702 EVS encoder
10 703 Stereo encoder
802 EVS decoder
803 Stereo decoder

1. An encoder, comprising:
first coding circuitry, which, in operation, encodes an input signal by selectively using, in a core layer, coding in a time domain or a frequency domain in accordance with a characteristic of the input signal; and
second coding circuitry, which, in operation, encodes a coding error by the first coding circuitry by using, in an extension layer with respect to the core layer, a coding method corresponding to a domain type of the coding used in the core layer.

2. The encoder according to claim 1, wherein in a case where the coding used in the core layer is the coding in the time domain, the coding method in the extension layer is independent of a plurality of candidate coding methods in the coding in the time domain.

3. The encoder according to claim 2, wherein the coding method in the extension layer is a Low Delay-Code Excited Linear Prediction (LD-CELP) coding mode.

4. The encoder according to claim 1, wherein in a case where the coding used in the core layer is the coding in the frequency domain, the coding method in the extension layer is a coding method in the frequency domain.

5. The encoder according to claim 4, wherein the coding error is an error between a decoded spectrum including a band extension component in the coding in the core layer and a spectrum of the input signal.

6. The encoder according to claim 4, wherein the coding error is an error between a decoded spectrum including no band extension component in the coding in the core layer and a spectrum of the input signal.

7. The encoder according to claim 1, wherein the input signal is a sum signal indicating a sum of a left-channel signal and a right-channel signal which configure a stereo signal.

8. The encoder according to claim 1, wherein:
the first coding circuitry includes Linear Predictive Coding (LPC) coding circuitry, and
the encoder further comprises:
first pre-emphasis circuitry, which, in operation, performs first pre-emphasis processing on the input signal to the LPC coding circuitry; and
second pre-emphasis circuitry, which, in operation, performs second pre-emphasis processing on the input signal to the second coding circuitry, the second pre-emphasis processing differing from the first pre-emphasis processing in emphasis intensity.

9. The encoder according to claim 1, further comprising:
error calculation circuitry, which, in operation, calculates the coding error by the first coding circuitry; and
de-emphasis circuitry, which, in operation, performs de-emphasis processing on a signal inputted to the error calculation circuitry.

10. A decoder, comprising:
first decoding circuitry, which, in operation, decodes coding information of an input signal encoded by selectively using, in a core layer, coding in a time domain or a frequency domain in accordance with a characteristic of the input signal; and
second decoding circuitry, which, in operation, decodes coding information of a coding error by the coding in the core layer, the coding error being encoded by using, in an extension layer with respect to the core layer, a coding method corresponding to a domain type of the coding used in the core layer.

11. The decoder according to claim 10, further comprising:
first de-emphasis circuitry, which, in operation, performs first de-emphasis processing on a decoded signal outputted from the first decoding circuitry; and
second de-emphasis circuitry, which, in operation, performs second de-emphasis processing on a decoded signal outputted from the second decoding circuitry.

12. A coding method, comprising:
encoding, by an encoder, an input signal by selectively using, in a core layer, coding in a time domain or a frequency domain in accordance with a characteristic of the input signal; and
encoding, by the encoder, a coding error by the coding in the core layer by using, in an extension layer with respect to the core layer, a coding method corresponding to a domain type of the coding used in the core layer.

13. A decoding method, comprising:
decoding, by a decoder, coding information of an input signal encoded by selectively using, in a core layer, coding in a time domain or a frequency domain in accordance with a characteristic of the input signal; and
decoding, by the decoder, coding information of a coding error by the coding in the core layer, the coding error being encoded by using, in an extension layer with respect to the core layer, a coding method corresponding to a domain type of the coding used in the core layer.

14. A hybrid coding system, comprising:
the encoder according to claim 1;
a simulcast encoder; and
an analyzer that performs an analysis based on channel correlation with respect to the input signal, wherein
the analyzer calculates cross-correlation between channels in the input signal,
the analyzer switches an output destination of the input signal to the encoder in a case where a maximum value of the cross-correlation exceeds a threshold value, and
the analyzer switches the output destination of the input signal to the simulcast encoder in a case where the maximum value of the cross-correlation is equal to or less than the threshold value.
